(19) United States
(12) Patent Application Publication
(10) Pub. No.: US 2026/0222061 A1
(43) Pub. Date: Jul. 30, 2026

(54) MOBILE SATELLITE BEAM RESOURCE ALLOCATION

(71) Applicant: Viasat, Inc., Carlsbad, CA (US)

(72) Inventors: Nicholas G. BERNDSEN, Parker, CO (US); James E. PETRANOVICH, La Jolla, CA (US); Brian T. SLEIGHT, Carlsbad, CA (US); Michail K. TSATSANIS, Huntington Beach, CA (US); Anton HOFFMAN, San Diego, CA (US)

(21) Appl. No.: 19/147,276

(22) PCT Filed: Jan. 13, 2023
(86) PCT No.: PCT/US2023/010744

§ 371 Date: Jul. 10, 2025

(51) Int. Cl. H04B 7/204; H04B 7/02; H04B 7/06; H04B 7/185

(52) U.S. Cl. CPC H04B 7/2041; H04B 7/028; H04B 7/0617; H04B 7/0626; H04B 7/18513; H04B 7/18515

(57) ABSTRACT

Methods, systems, and devices for mobile satellite beam resource allocation are described. A communication service may be provided to mobile terminals via respective beamformed spot beams that track movement of the mobile terminals. A central server may perform resource element allocation by determining, for repeating time periods, interference events associated with the beams for a current time period, determining resource elements to associate with the interfering beams for the next time period, and directing reassignment of the beams to the resource elements for the next time period. Each beam may be assigned to one or more resource elements based on a quantity of mobile terminals within the coverage area of the beam or on a desired data rate of the mobile terminals. Power associated with the resource elements may be adjusted based on a data rate or user demand associated with the mobile terminals.

### CROSS REFERENCE

The present application is a 371 national phase filing of International Patent Application No. PCT/US2023/010744 by BERNDSEN et al. entitled, “MOBILE SATELLITE BEAM RESOURCE ALLOCATION”, filed Jan. 13, 2023, which is assigned to the assignee hereof and hereby incorporated by reference in its entirety.

### FIELD OF TECHNOLOGY

The following relates generally to communications, including mobile satellite beam resource allocation.

### BACKGROUND

Communications devices may communicate with one another using wired connections, wireless (e.g., radio frequency (RF)) connections, or both. Wireless communications between devices may be performed using a wireless spectrum that has been designated for a service provider, wireless technology, or both. In some examples, the amount of information that can be communicated via a wireless communications network is based on an amount of wireless spectrum designated to the service provider, and an amount of frequency reuse within the region in which service is provided. Satellite communications may use beamforming to establish beams to increase frequency reuse, however, providing a high level of frequency reuse in satellite communication systems employing beamforming presents challenges.

### SUMMARY

The described techniques relate to improved methods, systems, devices, and apparatuses that support mobile satellite beam resource allocation. For example, a communication service may be provided to mobile terminals via respective beamformed spot beams that track movement of the mobile terminals. A central server may perform resource element allocation by determining, for repeating time periods, interference events associated with the beams for the current time period, determining resource elements to associate with the interfering beams for the next time period, and directing reassignment of the beams to the resource elements for the next time period. Each beam may be assigned to one or more resource elements based on a quantity of mobile terminals within the coverage area of the beam or on a desired data rate of the mobile terminals. The allocation of resource elements or power associated with the beams may be adjusted based on a data rate or user demand associated with the beams.

### BRIEF DESCRIPTION OF THE DRAWINGS

FIG. 1 shows an example of a satellite communication system that supports mobile satellite beam resource allocation in accordance with examples described herein.

FIGS. 2A and 2B show examples of resources for a satellite communication system that supports mobile satellite beam resource allocation in accordance with examples described herein.

FIG. 3 illustrates an example of a satellite communication system that supports mobile satellite beam deconfliction in accordance with examples as disclosed herein.

FIG. 4 illustrates an example of another satellite communication system that supports mobile satellite beam deconfliction in accordance with examples as disclosed herein.

FIGS. 5A and 5B show block diagrams of a satellite communication system that supports mobile satellite beam resource allocation in accordance with examples as disclosed herein.

FIG. 6 illustrates an example timing diagram that supports mobile satellite beam resource allocation in accordance with examples as disclosed herein.

FIGS. 7A-7C illustrate example scenarios of different types of allocations of resource elements that support mobile satellite beam resource allocation in accordance with examples as disclosed herein.

FIG. 8 shows a block diagram of a beam manager that supports mobile satellite beam resource allocation in accordance with examples as disclosed herein.

FIG. 9 shows a block diagram of a beam/terminal block that supports mobile satellite beam resource allocation in accordance with examples as disclosed herein.

FIGS. 10 and 11 show flowcharts illustrating methods that support mobile satellite beam resource allocation in accordance with examples as disclosed herein.

### DETAILED DESCRIPTION

Beam-to-beam handoffs of mobile terminals can be a source of disruption to end-users due to lost or delayed packets or a change in beam congestion levels or capabilities. In some satellite communication systems, beam-to-beam handoffs of mobile terminals may be based on relative locations of the mobile terminals within adjacent fixed beams, which may not consider interference between beams. For example, the handoff may occur when the mobile terminal is within overlapping portions on the edges of the coverage areas of adjacent beams. At these locations, the mobile terminal may have a low signal-to-noise ratio (SNR) (e.g., when compared to the mobile terminal being at the center of the coverage area), resulting in performance degradation. To compensate, a lower coding rate may be instituted that provides more redundancy. However, this reduces the overall communication speed and is inefficient. Further, all of the edge portions of a coverage area of a beam must overlap with at least one of the other beams, requiring wide beams and significant beam overlap.

For mobile terminals on slow moving vehicles, such as automobiles or ships, handoffs may occur relatively infrequently, and the ensuing performance degradation and disruptions may have little overall effect on communications associated with the mobile terminals. But for mobile terminals on fast moving vehicles, such as aircraft, the performance degradation and disruptions caused by frequent beam-to-beam handoffs may occur relatively frequently so as to have a much greater effect on the communications. Either way, reducing the number of beam-to-beam handoffs to reduce the ensuing performance degradation and number of disruptions may be beneficial.

Techniques are described for performing resource element allocation for spot beams as the spot beams track moving mobile terminals in a satellite communication system. In some cases, multiple resource elements may be allocated to a single spot beam. In some cases, resource elements and/or power associated with each beam may be adjusted based on data rates or real-time user demand of the mobile terminals associated with the beams. Since data rates and user demands may fluctuate, this may allow each spot beam to provide data as needed or desired, thereby minimizing unused capacity. Alternatively, the data rate of the beams may be based on business considerations, such as a contracted link speed, a contracted priority, a service layer agreement, or a business value associated with the mobile terminals. This may allow for respective data rates consistent with business considerations. In some cases, adaptive coding and modulation (ACM) behavior may be dynamically modified based on power and/or resource element changes associated with the beams. In some cases, the resource element allocation of the spot beams may be performed at a single central server. Using a single central server, the use of resource elements may be coordinated, leading to more efficient use of resource elements. As the mobile terminals move, the single central server may coordinate the assignment and reassignment of the beams to resource elements based on a quantity of mobile terminals within the coverage area of the beam or based on a desired data rate of the mobile terminals. This may be especially beneficial around airports, where more mobile terminals are within a smaller area.

Aspects of the disclosure are initially described in the context of satellite communication systems. Aspects of the disclosure are further illustrated by and described with reference to apparatus diagrams, system diagrams, block diagrams, and flowcharts that relate to mobile satellite beam deconfliction.

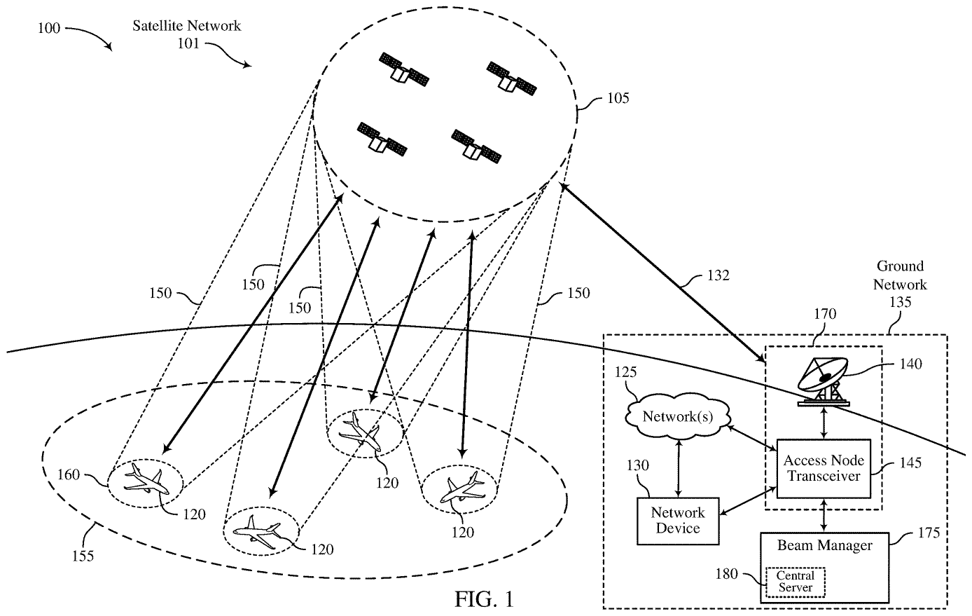

FIG. 1 shows an example of a satellite communication system 100 that supports mobile satellite beam resource allocation in accordance with examples described herein. Satellite communication system 100 may include a ground network 135 and a satellite network 101 configured to track and provide communication service to one or more mobile terminals 120.

The ground network 135 may include a collection of earth stations 170 having access nodes 140 configured to communicate with the satellite network 101 via a feeder link 132 (e.g., one or more satellite beams). The access nodes 140 may be coupled with access node transceivers 145 that are configured to process signals received from and to be transmitted through corresponding access node(s) 140. The access node transceivers 145 may also be configured to interface with a network 125 (e.g., the Internet)—e.g., via a network device 130 (e.g., a network operations center, satellite and gateway terminal command centers, or other central processing centers or devices) that may provide an interface for communicating with the network 125.

The ground network may also include a beam manager 175 for controlling the tracking of mobile terminals as communication service is provided to the terminals via beamformed spot beams, coordinating resource elements used by the beams, and performing deconfliction between associated beams, as discussed herein. Beam manager 175 may retrieve information (e.g., associated with the satellite network 101 and the terminals 120) from the satellite network 101 (e.g., via feeder link 132 and an access node 140) for performing the controlling, and may send commands (e.g., to the satellite network 101 and/or the terminals 120) accordingly (e.g., via the access node and feeder link).

In some embodiments, beam manager 175 may be a single device. Alternatively, beam manager 175 may be distributed throughout the system, e.g., in two or more elements of the satellite network and/or the ground network. For example, beam manager 175 may be incorporated into one or more devices of the ground network (e.g., a network device 130 or an access node transceiver 145), or one or more devices of the satellite network (e.g., in a single satellite 105 or distributed among multiple satellites), or a combination of devices in the ground network and the satellite network. In some embodiments, a first portion of beam manager 175 may be located in ground network 135 and a second portion may be located in satellite network 101.

In some embodiments, beam manager 175 may perform some or all of its functions at a single location by a single entity. For example, the resource element coordination of the beamformed spot beams may be performed at a central server 180. In some embodiments, beam manager 175 may originally assign the beams to a set of resource elements, and then, for repeating time periods: determine interference events associated with the beams for a current time period, determine which resource elements to associate with the interfering beams for a next time period, and direct reassignment of the beams to the resource elements for the next time period, all at central server 180.

Terminals 120 may include various devices configured to communicate signals with the satellite network 101. Although terminals 120 are illustrated as being on aircraft, terminals 120 may include fixed terminals (e.g., ground-based stationary terminals) or mobile terminals mounted on mobile platforms (e.g., boats, aircraft, ground-based vehicles, and the like), or a combination of fixed and mobile terminals. A terminal 120 may communicate data and information with an access node 140 via the satellite network 101. The data and information may be communicated with a destination device such as a network device 130, or some other device or distributed server associated with a network 125.

A variety of physical layer transmission modulation and coding techniques may be used by access nodes 140, and terminals 120, and components of the satellite network 101 (e.g., satellites) for the communication of signals. In some examples, Adaptive Coding and Modulation (ACM) may be used. ACM automatically changes the Forward Error Correction code rate and modulation utilized on a satellite link to compensate for changes in link conditions. In ACM, a modcod for each terminal may be adaptively tuned over time to meet the current requirements of the terminal. As channel conditions change, such as the fade varying during a rainy and non-rainy period, the modcod may adjust accordingly to become just adequate to compensate for the channel conditions.

The satellite network 101 may include one or more satellites 105 (e.g., a single satellite 105 or a network of satellites) that are deployed in space orbits (e.g., low earth orbits, medium earth orbits, geosynchronous orbits, geostationary orbits, etc.). Each satellite 105 included in satellite network 101 may be equipped with one or more antennas (e.g., a single antenna or an antenna array). In some examples, the one or more satellites 105 equipped with multiple antennas may each include one or more antenna panels that include an array of evenly distributed antennas (which may also be referred to as antenna elements). In some examples, a satellite may be equipped with an antenna array including antennas that are unevenly distributed across a large region. The ground network 135 may also contain access nodes 140 with multiple antenna array elements.

Terminals 120 may include an antenna assembly which may also include various hardware for mounting an antenna. An antenna assembly may also include circuits and/or processors for converting (e.g., performing frequency conversion, modulating/demodulating, multiplexing/demultiplexing, filtering, forwarding, etc.) between radio frequency (RF) satellite communication signals, and satellite terminal communications signals transmitted between the antenna and a satellite terminal receiver. For mobile terminals, the antenna assembly may be mounted on the outside of the mobile platform (e.g., outside of the fuselage of an aircraft). Additionally, or alternatively, the terminal 120 may include a transceiver, which may be mounted on the inside or outside of the mobile platform and may include circuits and/or processors for performing various RF signal operations (e.g., receiving, performing frequency conversion, modulating/demodulating, multiplexing/demultiplexing, etc.).

The satellite network 101 may have a large aperture size, which may be spanned by the antenna arrays or multiple satellites of the satellite network 101. Beam manager 175 may use the one or more satellites to support beamforming techniques within the coverage area 155 of the satellite communication system to increase a utilization of resources used for communications. Beam manager 175 may employ beamforming, including using multiple-input multiple-output (MIMO) techniques, to exploit multipath signal propagation and increase spectral efficiency by transmitting or receiving multiple signals via different spatial layers over the same frequency resources. Beam manager 175 may cause multiple signals, for example, to be transmitted by a transmitting device (e.g., a satellite 105) via a set of antennas in accordance with a set of weighting coefficients. Likewise, the multiple signals may be received by a receiving device (e.g., a satellite terminal 120) via a set of antennas in accordance with a set of weighting coefficients. Each of the multiple signals may be associated with a separate spatial stream and may carry bits associated with the same data stream (e.g., the same codeword) or different data streams (e.g., different codewords).

In some examples, some or all of the antenna elements on the satellites 105, the ground network 135, and/or the terminals 120 may be arranged as an array of constituent receive and/or transmit feed elements that cooperate to enable various examples of on-board beamforming (OBBF), ground-based beamforming (GBBF), end-to-end beamforming, or other types of beamforming. In the GBBF implementation, there may be multiple transmit or receive antennas on the ground network access node(s).

Beam manager 175 may determine weighting coefficients to apply to the set of antennas. For example, for N spatial layers to be formed, beam manager 175 may utilize an (Mx N) MIMO matrix, where M may represent the quantity of antennas of the set of antennas. In some examples, M may be equal to N. Beam manager 175 may determine the MIMO matrix based on a channel matrix and may use the MIMO matrix to isolate the different spatial layers of the channel. In some examples, beam manager 175 may select the weighting coefficients to emphasize signals transmitted using the different spatial layers while reducing interference of signals transmitted in the other spatial layers. Accordingly, processing signals received at each antenna of the set of antennas (e.g., a signal received at the set of antennas) using the MIMO matrix may result in multiple signals being output, where each of the multiple signals may correspond to one of the spatial layers. In some examples, the weighting coefficients used for MIMO communications may be referred to as beam coefficients or beamforming coefficients, and the multiple spatial layers may be referred to as beams or spot beams.

Beam manager 175 may determine the elements of the MIMO matrix used to form the spatial layers of the channel based on channel sounding probes. Channel sounding probes may include reference signals transmitted periodically between satellite network 101 and a device (e.g., a terminal 120) coupled with the satellite network. For example, a channel sounding probe may be periodically transmitted from a terminal 120 to a satellite 105, or from the satellite to the terminal, or both, and may include a sequence that is known to the transmitter and receiver (e.g., based on a terminal identifier or other parameters known to the transmitter and receiver). The receiving device (e.g., the terminal or the satellite) may use the received channel sounding probe to evaluate the connection by correlating the received channel sounding probe to the expected signal for the channel sounding probe (e.g., to determine a signal strength, an interference, etc.) and make decisions based thereon. Due to the periodicity of the signal, the receiving device may know when the signal should be received.

Beam manager 175 may use beamforming techniques to shape or steer a communication beam along a spatial path between one or more satellites and a mobile terminal 120 within a geographic area. Beam manager 175 may cause a communication beam to be formed by determining weighting coefficients for antenna elements of an antenna array that result in the signals transmitted from or received at the antenna elements being combined such that signals propagating in a particular orientation with respect to an antenna array experience constructive interference while others experience destructive interference. Thus, beamforming may be used to transmit signals having energy that is focused in a direction of a communication beam and to receive signals that arrive in a direction of the communication with increased signal power (relative to the absence of beamforming). Beam manager 175 may use the weighting coefficients to apply amplitude offsets, phase offsets, or both to signals carried via the antennas.

In some examples, beam manager 175 may apply the weighting coefficients to the antennas to form multiple beams, each associated with a different direction, where the multiple beams may be used to communicate multiple signals having the same frequency at the same time to different user terminals. This may be referred to as Multiuser MIMO. The weighting coefficients used for beamforming may be referred to as beam coefficients, and the multiple signals may be referred to as beam signals. The resulting beams may be referred to herein as beamformed spot beams, spot beams, or beams.

Beam manager 175 may calculate the amplitude and phase of each weighting coefficient given the antenna array and reflector geometry and location and the desired beam locations. However, due to inaccuracies (e.g., in the satellite locations, array orientation, geometry, atmospheric scintillation effects, etc.), such an approach may be impractical. Instead, beam manager 175 may calculate the weighting coefficients using continuous or periodic measurements of the MIMO propagation channel characteristics (e.g., pairwise channels from each system antenna element to each terminal antenna element) and adjusting the weighting coefficients based on the changing channel characteristics. The measured MIMO channel characteristics may include pairwise gain and phase response and noise level and may be referred to as MIMO channel state information (CSI). Once the MIMO CSI is available, beam manager 175 may derive the weighting coefficients by solving a set of equations or applying a set of adaptation formulas. Various beamformer calculation and adaptation techniques may be used, including minimum mean square (MMSE) beamformer, zero forcing beamformer, MIMO sphere decoder, and others.

The measurement of MIMO CSI may include the collaboration of at least one terminal for each beam. The situation may be different for the forward link direction (from the satellites to the terminals) versus the return link direction (from the terminals to the satellites). In the return link, each terminal may transmit a channel probing signal that may be orthogonal to probing signals of the other terminals. The satellites may determine which channel probing signal is transmitted from each terminal and may process the signal to estimate the channel parameters of the channel corresponding to that terminal. As such, the MIMO CSI on the return link may be computed locally on the satellite side for terminals that transmit channel probing signals. In contrast, on the forward link, the satellites may transmit channel probing signals. Different antenna elements may transmit signals that are orthogonal to each other. Each terminal tasked to compute MIMO CSI may do so by processing the probing signal corresponding to each transmit antenna element. Further, each such terminal may transmit the MIMO CSI back to a satellite using a return link control channel.

The spot beams generated that way may be tailored to the MIMO CSI provided by the user terminals and each beam may illuminate the direction of each such terminal. Each beam has a finite coverage area 160 (e.g., several km diameter) and may therefore illuminate additional terminals that may be in the vicinity of the CSI generating terminal. These additional terminals may not provide CSI, as this may unnecessarily increase the CSI reporting channel overhead. The terminal that is used to provide MIMO CSI per beam may be considered the reference terminal for that beam. In some examples, the coverage area 160 of a beam may be determined based on the wavelength of the carrier wave and the diameter of the aperture. The coverage area 160 may correspond, e.g., to a footprint where the power level of the beam is above a threshold, or where the power level drop-off away from the center of the beam is less than a threshold amount (e.g., 3 decibels (dB) or 6 dB). In some examples, the coverage area 160 may be based on a beam width of the beam.

In some examples, one or more aircraft-based terminals 120 may be sufficiently separated in distance from each other and from the other aircraft, so that beam manager 175 may use a separate beam for each of the one or more terminals. In some examples, two or more of the terminals 120 may be in close proximity (e.g., at an airport) such that beam manager 175 may illuminate the terminals by a same beam. In the former case, each terminal on an aircraft may be a reference terminal for its beam, while in the latter case, one of several terminals on aircraft may serve as a reference terminal for the beam.

As the mobile terminal 120 moves in the airspace, the MIMO CSI may change, causing the direction of the beam to change. Beam manager 175 may adjust the beam direction based on the changed MIMO CSI so that the reference terminal may remain at or near the center of the beam. Therefore, as the reference terminal moves, the beam may follow its movement, as further explained herein.

Beam manager 175 may associate the beamformed spot beams with a set of resources of the satellite communication system 100 (at central server 180). The set of resources may include, e.g., frequency resources, time resources, and polarization resources. For example, a given frequency range for the satellite communication system 100 may comprise frequency resources or channels, and a given amount of time may comprise different recurring time slots. For example, beam manager 175 may use a frequency channel to carry a signal (e.g., a modulated signal carried in a beamformed spot beam) on one of the recurring time slots. By doing this, beamformed spot beams may overlap spatially without interfering if they are associated with different frequency/time resource combinations. In addition, beam manager 175 may use multiple polarizations such that two beamformed spot beams may overlap spatially without interfering if they are associated with different polarizations.

Thus, beamformed spot beams may overlap spatially without interfering if they are associated with different combinations of the resources (e.g., frequency channel/time slot/polarization combinations). The different combinations may be known as resource elements that together form a set of resource elements that may be used by beam manager 175 for communicating signals over a beam. Beam manager 175 may control the association of the beams with the resource elements and determine when to reassign the beams (e.g., at central server 180), as discussed herein.

As discussed herein, beam manager 175 may adjust the individual coverage areas or footprints of the beamformed spot beams (e.g., by adjusting the weighting coefficients) so as to track (e.g., move in concert with) the respective mobile terminals (e.g., reference terminals). This may allow communication service associated with a mobile terminal to be provided via a same beamformed spot beam as the mobile terminal moves through the coverage area of the satellite communication system. This may reduce the number of beam-to-beam handoffs of the mobile terminals, which may reduce performance degradation and communication disruptions that can result from beam-to-beam handoffs. For example, a beam-to-beam handoff may require the beam handing off the terminal to coordinate with the beam receiving the terminal, which may require communication spanning several communication layers to transfer terminal information between access points (e.g., gateways, gateway modems) serving the beams and to verify the transfer. This may result in performance degradation and communication disruptions between beams.

Conflicts may occasionally arise between beams as the beams track mobile terminals, such as when two or more movable beamformed spot beams overlap spatially while using a same resource element (e.g., the same frequency channel, time slot, polarization combination). But these conflicts may be resolved using deconfliction procedures discussed herein. For example, when such a conflict occurs (e.g., based on interference metrics of the beams satisfying a threshold), beam manager 175 may cause one or more of the conflicting beams to change to different resource elements. As a result, little or no performance degradation may result. And because the deconfliction may involve only a single beam (e.g., without communication across access points serving different beams), communication disruption associated with handoff between beams may be avoided.

Further, as the reference terminals move, they may remain centrally positioned within the coverage areas of the beams. This may allow the SNR of the reference terminals to remain high so that overall communication speed and efficiency associated with the reference terminals may also be high.

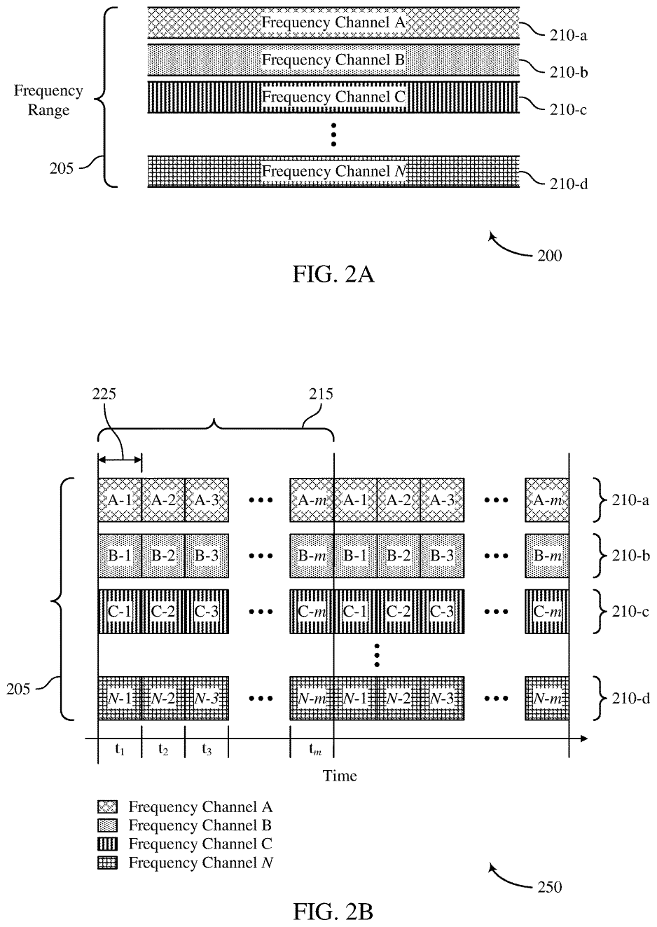

FIG. 2A shows an example of resources 200 for a satellite communication system that support mobile satellite beam resource allocation in accordance with examples described herein. Resources 200 may correspond to frequency divisions of a satellite communication system. For example, a frequency range 205 (e.g., a frequency band) may comprise a set of different frequency resources or frequency channels 210 (e.g., frequency channel 210-a, frequency channel 210-b, frequency channel 210-c, frequency channel 210-d) that carry signals between the satellite network and the terminals. The resources 200 may correspond to the frequency channels 210 of the frequency range 205.

Each frequency channel 210 may carry signals associated with a single terminal (e.g., at a time). For example, each frequency channel 210 may carry a single modulated signal. Information (e.g., data, control information) may be modulated onto the modulated signal using a variety of single-carrier or multi-carrier modulation techniques (e.g., Orthogonal Frequency Division Multiplexing (OFDM), Direct Sequence Spread Spectrum (DSSS), linearly pre-coded OFDM (LP-OFDM)). A beamformed spot beam may be associated with one or more frequency channels 210 (e.g., by beam manager 175), to provide communication to and track mobile terminals as discussed herein.

In the example of FIG. 2A, the resources 200 may correspond to the frequency channels 210. That is, each frequency channel 210 may be a separate resource 200. As there are no other types of resources, the separate resources may also be resource elements in some examples. As such, in this example the number of available resource elements may correspond to the number of frequency channels, N.

FIG. 2B shows an example of resource elements 250 for a satellite communication system that support mobile satellite beam resource allocation in accordance with examples described herein. In this example, frequency channels 210 may again be used to carry signals associated with the terminals. In addition, the frequency channels 210 may be time multiplexed. That is, each frequency channel 210 may be configured to carry signals to the terminals in time slots that repeat after a period of time. For example, a time period 215 may be divided into a set of sub-periods or time slots t (e.g., time slot t₁, time slot t₂, time slot t₃, time slot tₘ) each having a length 225. Each frequency channel 210 may carry a signal to a different terminal during each time slot t, although in some cases multiple time slots within a time period 215 may be allocated to the same terminal. For example, each frequency channel 210 may carry a single modulated signal during each time slot t. Information (e.g., data, control information) may be modulated onto the modulated signal using a variety of single-carrier or multi-carrier modulation techniques (e.g., OFDM, DSSS, LP-OFDM) to provide communication to and track mobile terminals (e.g., by beam manager 175), as discussed herein.

At the completion of the time period 215, the process may repeat such that each frequency channel 210 may carry further signals associated with the different terminals in a resource period. As a result, beam manager 175 may use the frequency channel 210 for communication with the terminal during one time slot t per time period 215. In some examples, beam manager 175 may assign a terminal to more than one time slot per time period, and thus communication with a terminal may occur over more than one time slot per time period for the frequency channel 210.

In the example of FIG. 2B, the resource elements 250 may correspond to the combinations of frequency channels 210 and time slots t in a time period 215. That is, each unique combination of frequency channel 210 and time slot t may be a separate resource element 250. As such, in this example the number of available resource elements may correspond to the number of frequency channels times the number of time slots, or N×m. Thus, this example may provide more resource elements than the example of FIG. 2A.

In addition to being multiplexed in time or frequency, different polarizations may be used to define the resource elements for assignment to beamformed spot beams. For example, a set of resource elements may include a first sub-set of resource elements associated with a first polarization and a second sub-set of resource elements associated with a second, orthogonal, polarization. The first and second polarizations may be orthogonal polarizations, and may be linearly polarized or circularly polarized (e.g., a right-hand circular polarization (RHCP), a left-hand circular polarization (LHCP)). Thus, a set of resource elements available to beam manager 175 for assignment to beamformed spot beams may be defined according to frequency resources (e.g., frequency channels), time resources (e.g., sub-periods of resource periods), or polarization resources.

In some examples, the types of resource elements may be combined. For example, in the same system, one or more frequency channels may be divided into time slots (e.g., as in FIG. 2B) and one or more other frequency channels may be used, undivided (e.g., as in FIG. 2A), as separate resource elements. Other combinations are also possible.

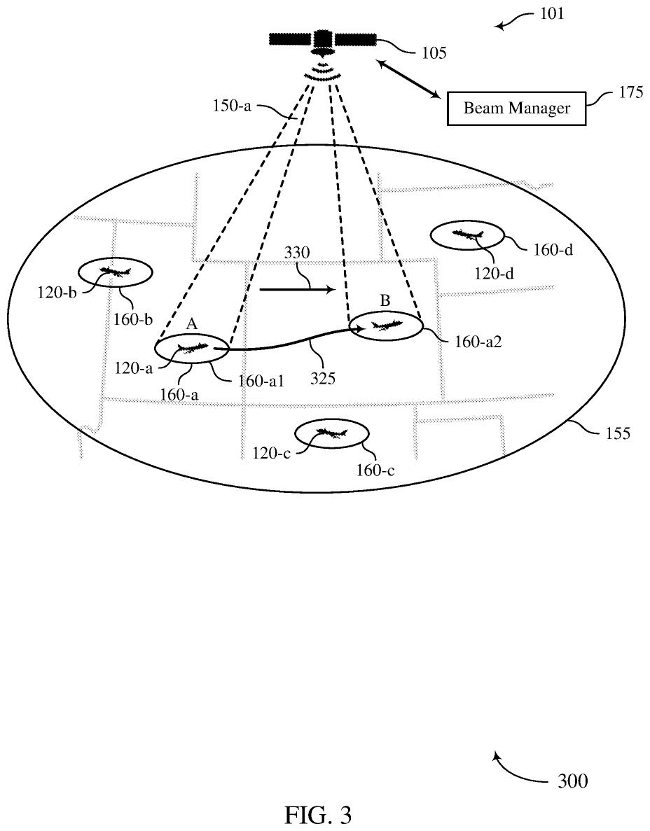

FIG. 3 illustrates an example of a satellite communication system 300 that supports mobile satellite beam resource allocation in accordance with examples as disclosed herein. The satellite communication system 300 may be an example of satellite communication system 100 as described with reference to FIG. 1 or aspects thereof. Satellite communication system 300 may include a satellite network 101 having one or more satellites 105 configured to generate beamformed spot beams 150 (e.g., beam 150-a) for communicating with a set of terminals 120 (e.g., terminals 120-a, 120-b, 120-c, 120-d) within a coverage area 155 of the satellite communication system, as directed by a beam manager 175. Beamformed spot beams may be referred to herein as spot beams or beams.

The terminals 120 may be located on movable platforms or vehicles, such as automobiles, boats, or aircraft, and thus may be considered to be mobile terminals 120. In some examples, each vehicle may include a single mobile terminal. In other examples, one or more vehicles may each include two or more mobile terminals. At least some of mobile terminals 120 may be multi-user mobile terminals, and thus the satellite communication system 300 may provide a communication service to multiple user devices (e.g., smartphones, laptops, tablets) connected via the mobile terminals 120.

In some examples, the satellite communication system 300 may provide communication service to the mobile terminals 120 via a set of movable beamformed spot beams 150 that track the mobile terminals, as controlled by beam manager 175, during movement of the mobile terminals. For the sake of clarity, only a single movable beamformed spot beam 150-a is illustrated in FIG. 3 associated with a single mobile terminal 120-a. Although not illustrated in FIG. 3, movable beamformed spot beams 150 may also be associated with one or more of the other mobile terminals 120.

In some examples, beam manager 175 may associate each beamformed spot beam 150 with a different mobile terminal 120. Each mobile terminal 120 associated with its own spot beam may be referred to as a reference terminal. Each spot beam 150 may have a respective coverage area 160 (e.g., coverage areas 160-a, 160-b, 160-c, 160-d). The coverage area may correspond, for example, to a footprint where the power level of the beam is above a threshold, or where the power level drop-off away from the center of the beam is less than a threshold amount (e.g., 3 dB or 6 dB).

In some examples, a beamformed spot beam associated with a reference terminal may be formed (e.g., as controlled by beam manager 175) to include the terminal's physical location within the coverage area of the beamformed spot beam. For example, as shown in FIG. 3, mobile terminal 120-a, acting as a reference terminal, may be physically located within the coverage area 160-a of beamformed spot beam 150-a and mobile terminals 120-b, 120-c, and 120-d may be physically located within the coverage areas 160-b, 160-c, and 160-d of their respective beamformed spot beams (not shown). The satellite communication system 300 may provide communication service (e.g., via beam manager 175) to mobile terminal 120-a via beamformed spot beam 150-a.

In some examples, beam manager 175 may cause a beamformed spot beam to track a moving mobile terminal while communication service is provided to the terminal via the beam. For example, as mobile terminal 120-a physically moves from location A to location B, as indicated by arrow 325, beamformed spot beam 150-a may “move” so as to track the mobile terminal, as indicated by arrow 330. In some examples, to “move” a beamformed spot beam, beam manager 175 may change and apply the beamforming coefficients associated with the beamformed spot beam to the signal associated with the beamformed spot beam. This may change the directionality of the beamformed spot beam (e.g., “move” the beam) so that the coverage area of the beamformed spot beam changes (e.g., “moves”).

To follow or track a mobile terminal, the beamforming coefficients may be changed by beam manager 175 such that the coverage area of the beamformed spot beam may move to reflect the movement of (e.g., may be moved in concert with) the mobile terminal. Beam manager 175 may continually adjust the coverage area (e.g., by periodically changing the beamforming coefficients to provide continuous coverage) to continue to correspond with the moving physical location of the moving mobile terminal and thereby track the mobile terminal. For example, beam manager 175 may move the coverage area 160-a of beamformed spot beam 150-a (e.g., from coverage area 160-a1 to coverage area 160-a2) so as to encompass the physical location of mobile terminal 120-a as mobile terminal 120-a moves from location A to location B. This may allow communication service associated with the mobile terminal to be provided via the same beamformed spot beam as the mobile terminal moves through the coverage area of the satellite communication system. For example, beam manager 175 may provide continuous communication service to mobile terminal 120-a via beamformed spot beam 150-a without a handoff as the mobile terminal moves between location A and location B.

In some examples, beam manager 175 may refrain from changing the beamforming coefficients associated with a mobile terminal while the mobile terminal is stationary because the coverage area of the beamformed spot beam may already correspond with the physical location of the stationary terminal. In other examples, beam manager 175 may change the beamforming coefficients even when a mobile terminal is stationary. For example, in some systems there may be a set of beamforming coefficients that may generate all of the beams from all of the beam signals. In those cases, even if only one terminal moves, beam manager 175 may change the beamforming coefficients used for all terminals.

In some examples, to track the mobile terminal, beam manager 175 may adjust the coverage area of the spot beam (e.g., move the spot beam) based on measurements of signals communicated with the mobile terminal. In some examples, the terminal may provide channel state information back to the satellite network on a regular and periodic basis, and beam manager 175 may process this channel state information to compute appropriate beamforming coefficients such that the beam energy for the beam signal associated with an aircraft is focused on that aircraft. As the aircraft moves, the channel state information may change, which in turn may induce changes in the beam weight coefficients computed by beam manager 175. Through this beamformer adaptation process, the beam center may be co-located with the aircraft location continuously (may follow the aircraft).

Alternatively, beam manager 175 may use an initial estimate of where to move the beam based on the latest speed and direction of travel of the mobile terminal. In some examples, beam manager 175 may move the spot beam in such a manner that as the mobile terminal moves, the mobile terminal may remain centrally positioned within the coverage area. This may allow the SNR of the mobile terminal to remain high so that overall communication speed and spectral efficiency associated with the mobile terminal may also be high.

In some examples, beam manager 175 may determine the position of the mobile terminal based on information received from the mobile terminal, such as location coordinates (e.g., determined via a positioning system such as GPS), a speed, a direction or other information associated with the mobile terminal. In some examples, beam manager 175 may determine the position of the mobile terminal based on information external to the mobile terminal, such as based on radar or other signals.

In some examples, the satellite communication system may provide the communication service to one or more mobile terminals via beamformed spot beams associated with the terminals. For example, in FIG. 3, beam manager 175 may establish beamformed spot beams 150 for each of mobile terminals 120-a, 120-b, 120-c, and 120-d, and may provide the communication service to the terminals and track the mobile terminals as the mobile terminals move within the coverage area 155 of the satellite communication system.

In some examples, beam manager 175 may use initial channel state information to determine the locations of the mobile terminals. Beam manager 175 may determine the initial channel state information based on measurements (e.g., signal strengths) of initial signals communicated with (e.g., transmitted to or received from) the mobile terminals. The initial channel state information may be based on respective first locations (e.g., location A for mobile terminal 120-a) of the mobile terminals within the coverage area 155. In some examples, the initial signals may include respective initial channel sounding probes communicated with the mobile terminals.

In some examples, to generate the beamformed spot beams, beam manager 175 may apply beamforming coefficients to convert between beam signals associated with each of the beamformed spot beams and component signals associated with a plurality of antenna elements of the satellite communication system. For example, to generate a spot beam for transmitting information to a mobile terminal, beam manager 175 may apply beamforming coefficients to beam signals (that contain the information) to obtain component signals that may be applied to the antenna elements; and to generate a spot beam for receiving information from a mobile terminal, beam manager 175 may apply beamforming coefficients to component signals received from the mobile terminal at the antenna elements to obtain beam signals that contain the information.

The plurality of antenna elements may be positioned on one or more of the satellites 105 or may be positioned on components of a ground network (not shown) of the satellite communication system 300 (e.g., access nodes 140 of ground network 135 as shown in FIG. 1). Beam manager 175 may use the beamforming coefficients to form the beamformed spot beams 150 between the satellites 105 and the coverage areas 160. Beam manager 175 may base the beamforming coefficients on the initial channel state information so that the coverage areas 160 of the beams 150 may encompass the respective first locations (e.g., location A) of the associated terminals 120.

The beamformed spot beams 150 may be forward-link beamformed spot beams (e.g., for transmitting information to the mobile terminals) and/or return-link beamformed spot beams (e.g., for receiving information from the mobile terminals). For example, the beamforming coefficients may include a plurality of sets of forward-link beamforming coefficients and a plurality of sets of return-link beamforming coefficients.

Beam manager 175 may apply a first set of the forward-link beamforming coefficients at a first time to a set of forward-link beam signals to generate a first set of forward-link component signals for transmission to one or more mobile terminals via the antenna elements at the first time. Transmission of the first set of forward-link component signals to the mobile terminals via the antenna elements may form forward-link beamformed spot beams, each corresponding to one of the mobile terminals for the first time.

Beam manager 175 may apply a second set of the forward-link beamforming coefficients at a second time to the set of forward-link beam signals to generate a second set of forward-link component signals for transmission to the mobile terminals via the antenna elements at the second time. Transmission of the second set of forward-link component signals to the mobile terminals via the antenna elements may form the forward-link beamformed spot beams, each corresponding to the mobile terminals for the second time. One or more of the forward-link beamformed spot beams at the second time may have moved from the corresponding forward-link beamformed spot beams at the first time to track movement of corresponding mobile terminals.

On the return link, beam manager 175 may apply a first set of the return-link beamforming coefficients at a first time to return-link component signals received from the mobile terminals via the antenna elements at the first time. Applying the first set of the return-link beamforming coefficients may form return-link beamformed sport beams, each corresponding to one of the mobile terminals, for the first time.

Beam manager 175 may apply a second set of the return-link beamforming coefficients at a second time to return-link component signals received from the mobile terminals via the plurality of antenna elements at the second time. Applying the second set of the return-link beamforming coefficients may form the return-link beamformed spot beams for the second time. One or more of the return-link beamformed spot beams at the second time may have moved from the corresponding return-link beamformed spot beams at the first time to track movement of the corresponding mobile terminals.

In some examples, beam manager 175 may use subsequent channel state information to determine subsequent locations of the mobile terminals. Beam manager 175 may determine the subsequent channel state information based on measurements (e.g., signal strengths) of subsequent signals communicated with the mobile terminals. The subsequent channel state information may be based on respective second locations (e.g., location B for mobile terminal 120-a) of the mobile terminals within the coverage area 155. Differences between the initial channel state information and the subsequent channel state information may be based on movement of the mobile terminals to the respective second locations.

In some examples, the subsequent signals may include respective subsequent channel sounding probes communicated with the mobile terminals. The revisions made to the beamforming coefficients may be based on the respective subsequent channel sounding probes. In some examples, the respective initial and subsequent channel sounding probes may be communicated with the mobile terminals at a first periodicity and the beamforming coefficients may be updated at a second periodicity based thereon.

In some examples, beam manager 175 may revise the beamforming coefficients and apply them to convert between the beam signals and the component signals associated with the plurality of antenna elements of the satellite network. The revised beamforming coefficients may be based on the subsequent channel state information so that the new coverage areas (e.g., coverage area 160-a2) of the beams may encompass the respective second locations (e.g., location B) of the mobile terminals.

The determination of subsequent locations of the mobile terminals and the revisions of the beamforming coefficients based thereon may be repeated by beam manager 175 as often and as long as desired. In this manner, the plurality of beamformed spot beams 150 may track movement of the reference terminals 120 throughout the coverage area 155 of the satellite communication system while communication service is provided to the terminals. In some examples, beam manager 175 may move a beamformed spot beam 150 to track its respective mobile terminal sufficiently often such that the associated coverage area at a current location may overlap the coverage area at the prior location. That is, each movement of the beamformed spot beam 150 may move the beam less than a diameter (e.g., or the radius, or a fraction such as one half of the radius) of the beamformed spot beam 150.

In some examples, the beamforming coefficients (e.g., initial beamforming coefficients and the revised beamforming coefficients) may include sets of beamforming coefficients. Each set of beamforming coefficients may correspond to a different time period for the set of beamformed spot beams. In some examples, the beamforming coefficients may be revised based on a characteristic, attribute, or condition satisfying (e.g., meeting, exceeding, and/or falling below) a threshold. For example, beam manager 175 may revise and apply beamforming coefficients based on a received signal quality (e.g., measured at the reference terminal or at the satellite communication system) falling below a threshold. This may allow the signal quality associated with the mobile terminal to remain high so that overall communication speed and efficiency associated with the mobile terminal may also be high. In some examples, beam manager 175 may determine the received signal quality based on the subsequent channel state information.

In some examples, two or more beams may use different resource elements for providing communication services to the respective mobile terminals. For example, beam manager 175 may cause each beam to use a different resource element (e.g., a different combination of frequency channel, time slot, and polarization) to provide communications to its respective mobile terminal while tracking the mobile terminal. By using different resource elements, interference between the beams may be reduced or eliminated, even when the mobile terminals may be close to each other.

In some examples, two or more beams may use a same resource element for providing communication services to the respective mobile terminals. For example, beam manager 175 may cause two or more beams to use a same combination of frequency channel, time slot, and polarization to provide communications to respective mobile terminals while tracking the mobile terminals. This may be desirable when the mobile terminals are far enough apart so that the respective beams do not interfere with each other. By using the same resource elements, more beams may be used with a particular set of resources, thereby increasing frequency reuse.

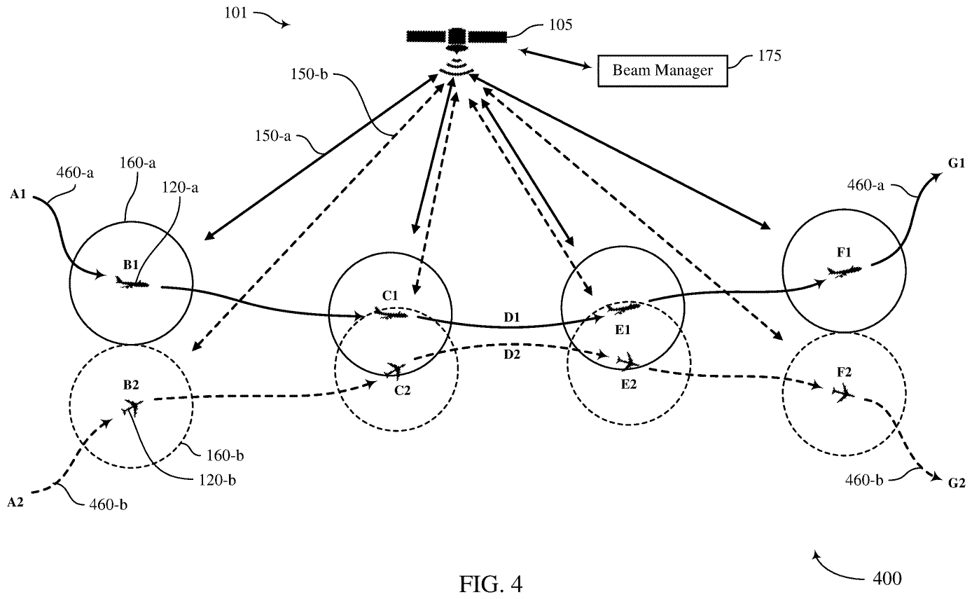

FIG. 4 illustrates another example of a satellite communication system 400 that supports mobile satellite beam resource allocation in accordance with examples as disclosed herein. The satellite communication system 400 may be an example of the satellite communication systems discussed herein, such as satellite communication systems 100 or 300 described with reference to FIG. 1 or FIG. 3 or aspects thereof.

Satellite communication system 400 may include a satellite network 101 having one or more satellites 105 configured to generate movable beamformed spot beams 150 (e.g., beams 150-a and 150-b) for communicating with mobile terminals 120 (e.g., mobile terminals 120-a and 120-b) as the beamformed spot beams track the mobile terminals, as controlled by beam manager 175, discussed herein.

In some examples, each beamformed spot beam 150 may be associated with a different mobile terminal 120. For example, beam manager 175 may associate beamformed spot beam 150-a with mobile terminal 120-a and beamformed spot beam 150-b with mobile terminal 120-b. The beamformed spot beams 150 may have coverage areas 160 (e.g., coverage areas 160-a and 160-b). For the sake of clarity, the moving beamformed spot beam 150-a and associated coverage area 160-a corresponding to moving mobile terminal 120-a are shown in solid lines, and the moving beamformed spot beam 150-b and corresponding coverage area 160-b corresponding to moving mobile terminal 120-b are shown in dashed lines.

FIG. 4 shows an example of two mobile terminals 120-a and 120-b passing close by each other as they travel along respective paths 460-a and 460-b. As with beam 150-b and corresponding coverage area 160-b, the path 460-b corresponding to mobile terminal 120-b is shown in dashed lines. The mobile terminals 120-a and 120-b may travel from respective start locations, represented by A1 and A2, to respective end locations, represented by G1 and G2, along paths 460-a and 460-b. Beams 150-a and 150-b are shown as being on aircraft, although other mobile platforms may also be used. Beams 150-a and 150-b may respectively track mobile terminals 120-a and 120-b (e.g., by beam manager 175 adjusting their respective coverage areas 160-a and 160-b in concert with the movement of the mobile terminals) while communication services are provided to the mobile terminals via the beams as the mobile terminals move along the paths.

As mobile terminals 120 move closer to each other, interference between the associated beams 150 may increase (e.g., when the beams use the same resource element). As discussed herein, beam manager 175 may cause one or both of the beams to switch to a different resource element to ameliorate the interference.

At a point along the paths 460-a and 460-b, represented by B1 and B2, the beams may begin to overlap each other, e.g., by the mobile terminals moving toward each other. As used herein, beams may be considered to be overlapping based on the relative positions of the respective coverage areas of the beams. For example, beams 150-a and 150-b may be overlapping when their respective coverage areas 160-a and 160-b overlap each other. In some cases, the coverage area of a beam may be centered on the position of the mobile terminal that the beam is tracking. For example, coverage areas 160-a and 160-b may be centered on the position of mobile terminals 120-a and 120-b, respectively. In some examples, the overlapping of coverage areas may be based on a distance between the corresponding mobile terminals.

Further along the paths 460-a and 460-b, mobile terminals 120-a and 120-b may arrive at another point, represented by C1 and C2, at which one or more of the mobile terminals may enter into the coverage area of a beam that is not supporting (e.g., not providing communication service to or tracking) the mobile terminal (e.g., by the mobile terminals continuing to move toward each other). For example, at C1/C2, mobile terminal 120-a may enter into coverage area 160-b of beam 150-b, and/or mobile terminal 120-b may enter into coverage area 160-a of beam 150-a. At some point before or after this, interference between beams 150-a and 150-b may rise to an unacceptable level. For example, an interference metric of one or both beams may satisfy (e.g., meet; or exceed; or meet or exceed) a threshold value. Steps may be taken (e.g., by beam manager 175) to ameliorate the interference (e.g., deconflict the beams), as discussed herein.

The mobile terminals 120-a and 120-b may each remain in the coverage areas 160-a and 160-b of both beams 150-a and 150-b until another point along the paths 460-a and 460-b, represented by E1 and E2. At that point, the mobile terminals may stop being in the coverage areas of the other's beam (e.g., by the mobile terminals moving away from each other). For example, at E1/E2, mobile terminal 120-a may stop being in the coverage area 160-b of beam 150-b and mobile terminal 120-b may stop being in the coverage area 160-a of beam 150-a. Even after the mobile terminals each stop being in the coverage area of the other terminal, the beams may still overlap. For example, at E1/E2, the coverage areas 160-a and 160-b of beams 150-a and 150-b may still overlap.

The beams 150-a and 150-b may remain overlapping until another point along the paths 460-a and 460-b, represented by F1 and F2. At that point, the beams 150-a and 150-b may stop overlapping each other (e.g., by the mobile terminals continuing to move away from each other). From that point to G1/G2 along the paths 460-a and 460-b, the beams 150-a and 150-b may remain apart and not overlapping, as long as the mobile terminals remain far enough apart from each other.

As discussed with respect to FIGS. 2A and 2B, beam manager 175 may use resource elements to provide communication service to mobile terminals via beamformed spot beams. In some examples, if beams do not conflict (e.g., the interference between the beams is low), the beams may use a same resource element for providing communication service to the respective mobile terminals. For example, as long as respective interference metrics of beams 150-a and 150-b remain below a threshold value, beam manager 175 may use the same resource element to provide communications to mobile terminals 120-a and 120-b via beams 150-a and 150-b, as discussed herein.

As the mobile terminals 120-a and 120-b move closer to each other (e.g., A1/A2 through B1/B2 and C1/C2 to D1/D2), interference between the corresponding beams 150-a and 150-b may increase. The increase in interference may mean that communication via the separate beams is subject to too much inter-beam interference (e.g., when using the same resource element). When the interference rises to a level (e.g., the interference metric of at least one of the beams satisfies a threshold value), steps may be taken by beam manager 175 to deconflict (e.g., ameliorate the interference) of the beams.

In some examples, the interference metric may correspond to a measured interference of one or more beams. For example, the interference metric may correspond to a signal strength of a beam associated with a terminal. In some examples, the signal strength associated with the terminal may be measured at a second terminal. Additionally, or alternatively, the interference metric may correspond to the degradation of a beam's signal (e.g., a lower SNR) and the threshold may correspond to a specific level of the metric or specific amount of degradation (e.g., 3 dB or 6 dB SNR loss). In some examples, the beam interference may be measured at the receiving device of the communication link. For example, the beam interference may be measured at mobile terminals (for forward links) or satellites (for return links).

In some examples, the interference metric may correspond to a channel correlation. For example, the interference metric may be based on a correlation between channel state information of two or more mobile terminals. The interference metric may be frequency dependent.

In some examples, the interference metric may correspond to an estimated interference of one or more beams. For example, the estimated interference may be based on the distance between the mobile terminals or on an algorithm that estimates the interference between the associated beams. In some examples, the interference metric may be based on a distance between the mobile terminals associated with the beams and the threshold may correspond to a specific distance. For example, the threshold may correspond to the distance between mobile terminals at which the coverage areas of the corresponding beams begin to overlap (e.g., at B1/B2), or at which one of the mobile terminals enters into the coverage area of the beam corresponding to another mobile terminal (e.g., at C1/C2), or somewhere in-between. Other distances are also possible.

In some examples, each beam may have multiple interference metric values. For example, the interference metrics may correspond to interference between pairs of beams and interference between each pair may be separately compared with the threshold value. So each beam may have multiple interference values, one each between the beam and one of the other beams. For example, for three beams A, B, and C that are close together, beam A may have two separate interference values, one corresponding to the interference between beams A and B and one corresponding to the interference between beams A and C. Interference between beam pairs AB, ΔC, and BC may be separately compared with the threshold value and demodulation may be performed for the pairs of beams whose interference metrics satisfy the threshold value.

In some examples, each beam may have a single interference value. For example, the interference metrics may correspond to interference between a beam and multiple other beams (e.g., all the other beams). For example, for the same three beams A, B, and C, beam A may have a single interference metric value corresponding to an aggregate interference between beam A and beams B and C. For each beam, the aggregate interference may be compared with the threshold value and demodulation may be performed for the beam(s) whose interference metrics satisfy the threshold value.

Returning to the example shown in FIG. 4, beams 150-a and 150-b may both be originally assigned to a same resource element (e.g., at A1/A2) to provide communication service to their respective mobile terminals 120-a and 120-b. Mobile terminals 120-a and 120-b may be a substantial distance from each other at A1/A2, such that beams 150-a and 150-b do not conflict with each other (e.g., there may be little, if any, interference between beams 150-a and 150-b, even though they are assigned to the same resource element A). As such, an interference metric between beams 150-a and 150-b may be relatively low (e.g., below a threshold value). Beams 150-a and 150-b may be semi-statically assigned to the same resource element A (e.g., by beam manager 175), such that each terminal monitors the same resource element and/or transmits over the same resource element until the terminal receives an indication to switch its resource element.

The interference between the beams may rise to an unacceptable level (e.g., the interference metric may satisfy a first threshold value). In some examples, this may correspond to when one of mobile terminals 120 enters into the coverage area of the other beam 150 (e.g., at or near C1/C2). In some examples, this may correspond to mobile terminals 120-a and 120-b being between B1/B2 and C1/C2. Other locations may also be possible, based on when the interference metric value satisfies the first threshold value.

To ameliorate the interference, one or both of the beams may be changed to a different resource element (e.g., by beam manager 175). For example, in response to the interference metric satisfying the first threshold value, beam manager 175 may cause beam 150-b to switch resource elements (e.g., by reassigning beam 150-b to a resource element B that is different than resource element A) for providing communication service to mobile terminal 120-b. This may include changing one or more of the frequency channel, time slot, polarization, or other resource (e.g., one or more codes) associated with beam 150-b to be different than that used by beam 150-a. In some examples, resource element B may be orthogonal to resource element A.

After beam 150-b has been changed to a different resource element than beam 150-a, the interference between beams 150-a and 150-b may be greatly reduced or no longer present. Thus, the satellite communication system may continue to provide communication service to mobile terminal 120-b without a beam-to-beam handoff being performed.

When the interference (or potential interference) between the beams is no longer at an unacceptable level (e.g., an interference metric may not satisfy a second threshold value), beams 150-a and 150-b may again use a same resource element as each other. For example, beam 150-b may revert back to the original resource element (e.g., by beam manager 175 reassigning beam 150-b back to resource element A) for providing communication service to mobile terminal 120-b. Alternatively, beams 150-a and 150-b may continue to use different resource elements than each other. For example, instead of changing the resource element of beam 150-b back to resource element A, beam manager 175 may cause beam 150-b to continue using resource element B.

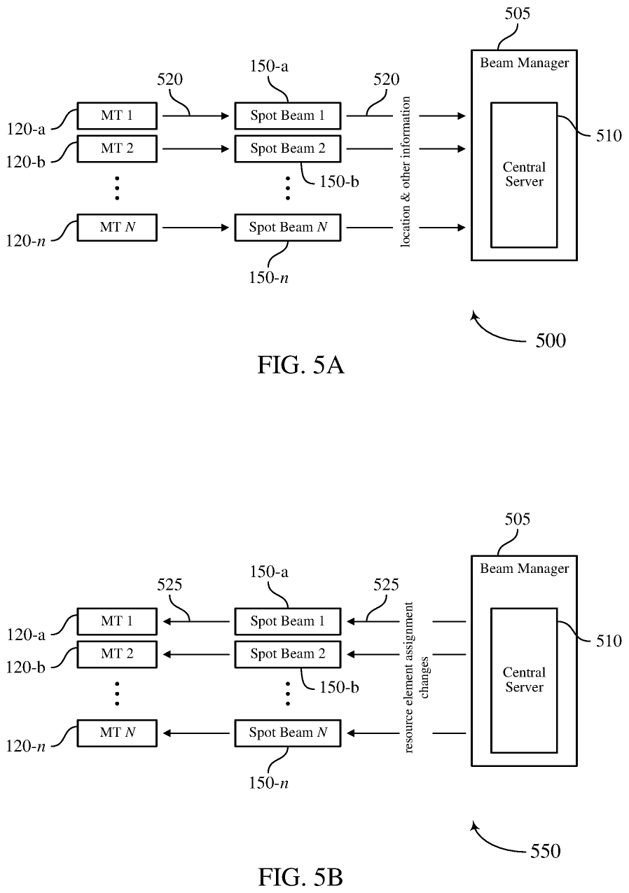

FIGS. 5A and 5B show block diagrams of satellite communication systems 500 and 550 that support mobile satellite beam resource allocation in accordance with aspects of the present disclosure. The satellite communication system 500 may include a beam manager 505 that communicates with the mobile terminals 120 (e.g., mobile terminals 120-a, 120-b, 120-n) via associated spot beams 150 (e.g., spot beams 150-a, 150-b, 150-n), respectively. In some embodiments, the communication may be coordinated at a central server 510. That is, beam manager 505 may coordinate, at central server 510, the use of resource elements by the spot beams. Beam manager 505 and central server 510 may be examples of the beam managers and central servers discussed herein, such as beam managers 175 and 805 and central server 180 or aspects thereof.

In some examples, beam manager 505 may be configured to communicate with all of the mobile terminals of the system. The spot beams may be respectively formed and moved by beamformers, as discussed herein. FIGS. 5A and 5B represent the communication flow between beam manager 505 (e.g., at central server 510) and the mobile terminals 120 at two different times.

FIG. 5A represents the communication flow when beam manager 505 obtains information associated with the mobile terminals 120 and the spot beams 150. The communication may flow from the mobile terminals 120 to beam manager 505 via spot beams 150, as depicted by arrows 520. In some examples, the information may include current information, such as position and other information, that may be used by beam manager 505 to determine when interference events occur between spot beams 150. The information may also include demand information including data volume in queues (e.g., forward or return link queues), user information (e.g., users connected to each mobile terminal 120, provisioned service for each of the connected users) or requested data rate for the next time period.

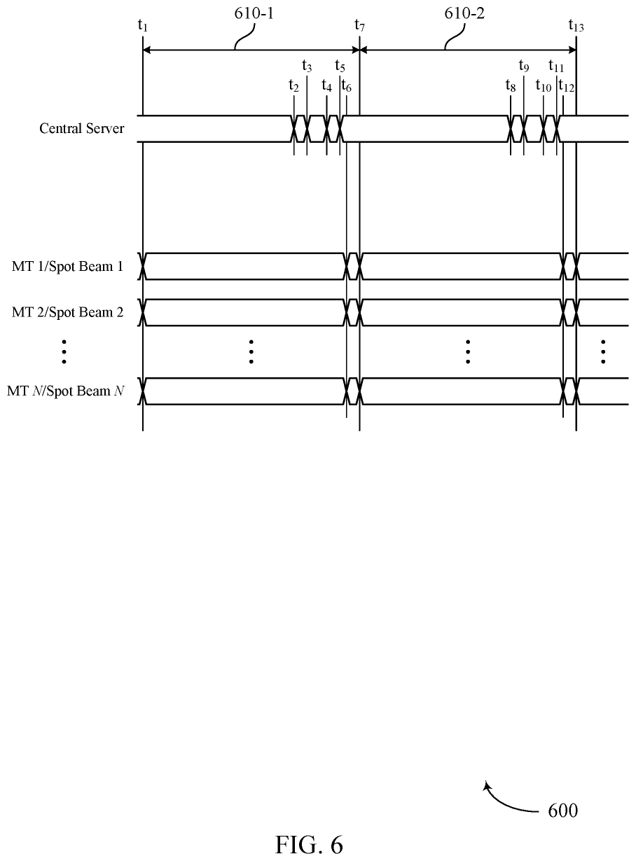

FIG. 5B represents the communication flow when beam manager 505 (e.g., at central server 510) transmits information associated with the mobile terminals 120 and the spot beams 150. The communication may flow from beam manager 505 to the mobile terminals 120 via spot beams 150, as depicted by arrows 525. In some examples, the information may include reassignment information, such as resource element assignment changes to be made, or beam power allocations, for the spot beams. In some examples, the reassignment information may also include a desired time to implement the changes. The reassignment information may be determined by beam manager 505 based on the current information obtained from the spot beams 150 and the mobile terminals 120. As discussed with respect to FIG. 6, the obtaining of current information (e.g., FIG. 5A) and transmitting of reassignment information (e.g., FIG. 5B) may occur during a same time period that may be repeated. In some examples, Beam manager 505 may send the reassignment information at the end of the time period for use during the next time period.

FIG. 6 shows an example timing diagram that supports mobile satellite beam resource allocation in accordance with aspects of the present disclosure. Timing diagram 600 represents timing of certain communications between the mobile terminals 120/spot beams 150 and beam manager 505 (e.g., at central server 510) of FIGS. 5A and 5B.

Timing diagram 600 may consist of multiple time periods 610 (e.g., time periods 610₁ and 610₂). For example, a first time period 610₁ may extend from a time t₁ to a time t₇ and a second time period 610₂ may extend from time t₇ to a time t₁₃. In some examples, the durations of the time periods 610 are equal. The time periods 610 may repeat such that the time periods may include similar activities performed at similar times within each time period. For example, actions performed at times t₂, t₃, t₄, t₅, and t₆ of the first time period 610₁ may be repeated at times t₈, t₉, t₁₀, t₁₁, and t₁₂ of the second time period 610₂. For ease of discussion, only activities associated with a “current” time period (e.g., the first time period 610₁) are discussed herein. It is appreciated that the discussion may also apply to similar actions of the other repeating time periods 610.

During each time period 610, one or more of the mobile terminals 120 may move and the beams 150 associated with the mobile terminals may track the movement (e.g., as controlled by beam manager 505). That is, the respective coverage areas of the beams 150 associated with the mobile terminals 120 may be adjusted during each time period 610 to track movement of the mobile terminals.

Time t₁ represents a beginning of first time period 610₁. At time t₁, the spot beams 150 may provide communication service to the mobile terminals 120 via a set of resource elements. Each spot beam 150 may be assigned to one or more of the resource elements by beam manager 505, as discussed herein.

Between times t₁, and t₂, beam manager 505 may obtain (e.g., collect) information associated with the mobile terminals 120 and spot beams 150 within the satellite communication system. The information may include information associated with the beams and/or mobile terminals for the current time period, such as a current position of each mobile terminal, the number of users connected to each mobile terminal, the volume of data waiting to be transmitted from queues (e.g., forward or return link queues), coverage area information associated with the spot beams, the current resources to which each spot beam is assigned, and other information.

Between times t₃ and t₅, beam manager 505 may determine resource element allocation for the spot beams 150. In some examples, the resource element allocation may be based on the information obtained before time t₃ during the current time period from the mobile terminals (e.g., current position, connected users, demand information). In some examples, the resource element allocation may be based on the respective locations of the mobile terminals.

Starting at time t₃, to determine the resource element allocation, beam manager 505 may determine interference events associated with the beams 150 for the current time period. In some examples, the interference events may be determined by beam manager 505 based at least in part on interference metrics of the beams. For example, an interference event between beams 150 may be determined to be occurring during the current time period when the interference metric of one or more of the beams satisfies a threshold value. Some possible interference metrics and thresholds are discussed with respect to FIG. 4.

Based on the determined interference events, beam manager 505 may determine a subset of the beams 150 to reassign to different resource elements. For example, when an interference event is determined to be occurring between two beams 150, beam manager 505 may determine that one or both beams 150 should be added to the subset for reassignment to different resource elements.

For each beamformed spot beam 150 of the subset, beam manager 505 may determine respective one or more resource elements to associate with the spot beams for the next time period. By doing this at central server 510 for all the spot beams in the system, beam manager 505 may keep track of which resource elements are associated with which beamformed spot beams 150 on a global level and may thus determine which resource elements are best used for each beam 150. For each beam 150 of the subset, the respective one or more resource elements may be different than the resource elements to which the beam 150 is currently assigned. The respective one or more resource elements for all spot beams of the subset may be determined before time t₄.

Starting at time t₄, beam manager 505 may direct, for use during the next time period (e.g., 610₂), reassignment of the subset of beams to the respective one or more resource elements. This may involve preparing various components, such as frequency converters, schedulers, polarization components, etc. associated with each beam. The directing may also include transmitting reassignment information to the associated mobile terminals 120 via the spot beams 150. The reassignment information may include a list of the one or more resource elements for the associated beam to use for the next time period. In some examples, the reassignment information may also include a specific time at which to implement the reassignments. In some examples, the respective mobile terminals associated with the subset of beams are notified of the reassignment. The preparation of the various components and/or transmission of the reassignment information may be completed before time t₅.

At time to, the various components associated with the subset of beams may implement the resource element assignment changes directed by beam manager 505 for use during the next time period (e.g., time period 610₂). For example, beam manager 505 may cause the various components to change one or more of the characteristics of each data stream used by the subset of beams (e.g., by changing the frequency, time slot, and/or polarization), which may cause the respective beams 150 to become reassigned to the one or more resource elements determined by beam manager 505 before time t₄.

In some examples, reassigning a set of beams to different resource elements to ameliorate interference between the beams may include assigning all the beams in the set to new resource elements. In some examples, reassigning a set of beams to different resource elements to ameliorate interference between the beams may include assigning some of the beams to new resource elements and leaving the assignment of other beams unchanged.

Time t₆ may occur any time after time t₅. In some examples, time to may correspond to the desired specific time (e.g., time period 610) included with the reassignment information sent to the mobile terminals. The assignment changes may trigger the next time period (e.g., time period 610₂) to begin.

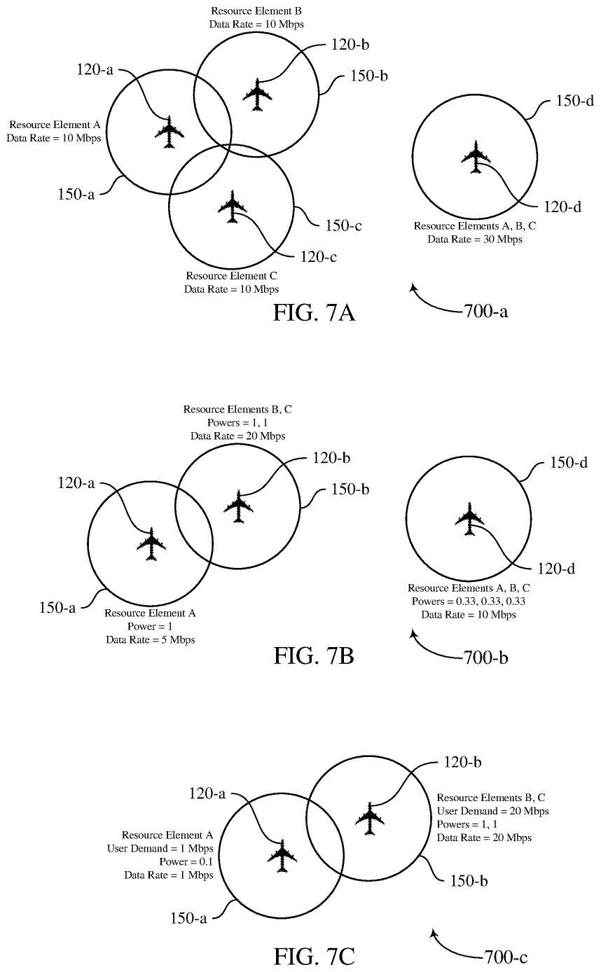

FIGS. 7A-7C illustrate example scenarios 700-a, 700-b, and 700-c of different types of allocations of resource elements that support mobile satellite beam resource allocation in accordance with aspects of the present disclosure. Scenarios 700-a, 700-b, and 700-c, correspond to scenarios in which beams have been associated with resource elements after at least some of the associated beams may have had potential interference events (e.g., as detected by beam manager 175). That is, the scenarios are illustrated after beam manager 175 has reassigned the beams to ameliorate the interference. In each scenario, each mobile terminal is assigned to its own beam.

To simplify the discussion, each beam is represented by its coverage area and the interference events are directly associated with an overlap of the coverage area. That is, in scenarios 700-a, 700-b, and 700-c, an interference event may occur between beams that use the same resource element when the corresponding coverage areas overlap. Thus, in scenarios 700-a, 700-b, and 700-c, the interference metric may include a comparison between coverage areas and the threshold value may correspond to an overlapping of the coverage areas such that the threshold value of the interference metric is satisfied when the coverage areas overlap.

Scenario 700-a illustrates four mobile terminals 120-a, 120-b, 120-c, and 120-d respectively assigned to four beams 150-a, 150-b, 150-c, and 150-d by beam manager 175 for providing communication service to the mobile terminals. Mobile terminals 120-a, 120-b, and 120-c are close enough to each other such that the coverage areas of associated beams 150-a, 150-b, and 150-c overlap each other. As such, interference metrics of any of the respective beams 150-a, 150-b, and 150-c may satisfy the threshold value when the beams are assigned to a same resource element. To avoid (or ameliorate) the interference, beams 150-a, 150-b and 150-c may be assigned (or reassigned) by beam manager 175 to resource elements that are different from each other (e.g., resource elements A, B, and C, respectively).

Mobile terminal 120-d is positioned at a distance from the other mobile terminals such that the coverage area of associated beam 150-d does not overlap the coverage areas of any of the other beams 150-a, 150-b, and 150-c. Because of this, the interference metric of beam 150-d, may not satisfy the threshold value, even if beam 150-d is assigned to the same resource elements as the other beams. As such, beam 150-d may be assigned by beam manager 175 to any of the resource elements A, B, or C.

In some examples, a beam may be assigned to more than one resource element. For example, in scenario 700-a, beam 150-d is assigned to all three resource elements A, B, and C by beam manager 175. Assigning a beam to more than one resource element may provide more capacity (e.g., data rate) to the beam, which may be beneficial in various ways. For example, in locations with many mobile terminals, assigning a beam to multiple resource elements may allow separate resource elements to be used by a single beam in providing communication service to multiple mobile terminals, ensuring all mobile terminals stay connected. In locations with few mobile terminals, assigning a beam to multiple resource elements may allow multiple resource elements to be used in providing communication service to a single mobile terminal, increasing total system capacity and data rate that the mobile terminal can achieve. For example, as shown in scenario 700-a, if the data rates associated with resource elements A, B, and C are 10 Mbps, the data rate associated with each of beams 150-a, 150-b, and 150-c may be 10 Mbps, while the data rate associated with beam 150-d may be a summation of the data rates associated with resource elements A, B, and C (e.g., 30 Mbps). As such, beams 150-a, 150-b, and 150-c may provide less capacity to corresponding mobile terminals 120-a, 120-b, and 120-c, while beam 150-d may simultaneously provide much greater capacity to mobile terminal 120-d.

In some examples, the quantity of resource elements to which a beam is assigned may be set or adjusted based on the quantity of mobile terminals located within the coverage area of the beam. For example, beam manager 175 may assign a higher quantity of resource elements to a beam that has many mobile terminals located within its coverage area. This may be beneficial, for example, at or near an airport, where there may be many mobile terminals within a small area.

In scenario 700-b, mobile terminal 120-c and its associated beam 150-c have been omitted and one of the other beams 150-a or 150-b may be assigned by beam manager 175 to the resource element to which beam 150-c was previously assigned. For example, in scenario 700-b, beam 150-c is assigned (or reassigned) by beam manager 175 to resource element C in addition to resource element B, which may result in a higher data rate for beam 150-b (e.g., 20 Mbps vs. 10 Mbps of scenario 700-a). Because beam 150-a is assigned to resource element A, an interference event may not occur between beams 150-a and 150-b even though the coverage areas of beams 150-a and 150-b may overlap.

In some examples, the allocation of resource elements and/or power to beams may be performed such that different users may be given similar or different capacities relative to each other. For example, different customers may require different speeds and priorities based on their contracts, service layer agreements, business values, etc.

In some examples, a power associated with a beam may be used to adjust the capacity of the beam associated with one or more resource elements. For example, setting the power level of a beam by beam manager 175 to less than the full power level of the beam may result in a lower data rate associated with each resource element to which the beam is assigned. For example, as shown in scenario 700-b, if the power of beam 150-c is set to 33% by beam manager 175, the resulting capacity associated with each beam may be reduced such that the capacity (data rate) of spot beam 150-c associated with each resource element is also reduced (e.g., 3.33 Mbps per Resource Elements A, B, and C vs. 10 Mbps of scenario 700-a). In some examples, the power may be adjusted by beam manager 175 by transmitting a signal to the mobile terminal that represents an adjustment to be made to the transmitting power associated with the mobile terminal. The power of the beam may be adjusted accordingly using the beamforming coefficients and/or by adjusting transmit power from one or more antenna elements.

In some examples, Adaptive Coding and Modulation (ACM) changes may be transmitted by the beam to the mobile terminal with the signal. In ACM, a modcod for each terminal may be adaptively tuned over time to meet the current requirements of the terminal. When power associated with a beam is adjusted, the modcod for the terminal associated with the beam may take time to “catch up” with the data. This time may be significant, especially with large instantaneous power changes. Until the modcod does catch up, data transmission to and from the mobile terminal may be significantly slower. By including the ACM changes with the signal, the mobile terminal may more quickly determine the modcod to use, thereby shortening or preventing the catch-up time. Further, no round-trip feedback is needed by the mobile terminal to determine the modcode. The same benefits may be obtained by including the ACM changes with the signal when interference changes are expected.

In some examples, the quantity of resource elements and the power associated with a beam may be used in conjunction with each other to adjust the capability of the beam. For example, as shown in scenario 700-b, the power of beam 150-d dedicated to the resource elements A, B, and C to which the beam is associated, may be set to 33% so that the data rate of beam 150-d (e.g., 10 Mbps) may be equal to what it would be if using only one of the resource elements at full power.

In some examples, the power associated with a beam and/or the quantity of resource elements to which a beam is assigned may be set or adjusted by beam manager 175 based on the mobile terminal or mobile terminals associated with the beam. For example, the power, quantity of resource elements (e.g., time slots, and/or frequency channels) may be based on a data rate (or desired data rate) associated with the mobile terminal. That is, beam manager 175 may set or adjust the quantity of time slots, the quantity of frequency channels assigned to the respective beams, and/or the power levels associated with the beams to provide desired data rates for the mobile terminals. In some examples, the data rates may be based on the user demand associated with the mobile terminals. For example, scenario 700-c illustrates beam 150-a having a data rate of 1 Mbps, based on a power level of 10% of the beam, to match a user demand of 1 Mbps of mobile terminal 120-a; and beam 150-b having a data rate of 20 Mbps, based on a quantity of resource elements, to match a user demand of 20 Mbps of mobile terminal 120-a.

In some examples, the power associated with a beam and/or quantity of resource elements to which the beam is assigned may be set or adjusted based on business considerations associated with the mobile terminal. For example, the power associated with a beam and/or quantity of resource elements to which the beam is assigned may be based on one or more of: a contracted link speed, a contracted priority, a service layer agreement, or a business value associated with the mobile terminal. In some examples, an aggregate power for all beams assigned to a given resource element may have a fixed (e.g., limited) value. For example, a specific amount of power may be dedicated to communication using a particular resource element and the specific amount of power may be divided among the beams assigned to the resource element, e.g., based on user demand or provisioned data rates, or both. Thus, allocating less power (e.g., 33%) to beam 150-d for using resource element B, as shown in FIG. 7B, may allow additional power to be allocated to beam 150-b for using resource element B. The beamforming coefficients used for forming the beams that use the resource element may effectively divide the power among the beams. It should be noted that although FIGS. 7B and 7C show a linear relationship between power and data rate, the relationship may be non-linear.

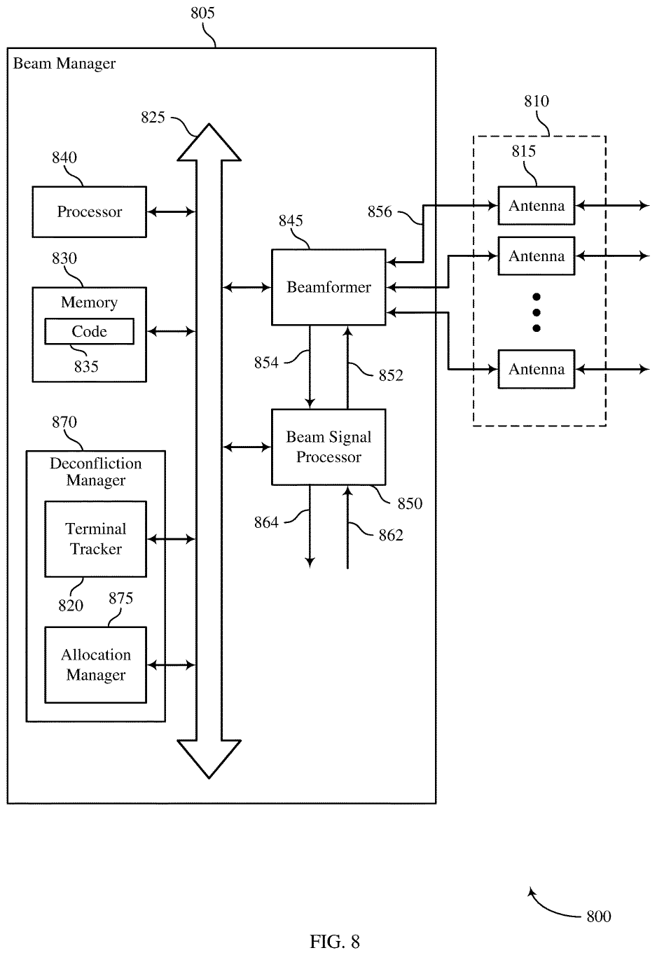

FIG. 8 shows a block diagram 800 of a beam manager 805 that supports mobile satellite beam resource allocation in accordance with examples as disclosed herein. Beam manager 805 may be an example of beam manager 175 of FIG. 1. Beam manager 805 may include a bus 825, a deconfliction manager 870, a memory 830, code 835, a processor 840, a beamformer 845, and a beam signal processor 850, and may be configured to control beam tracking of mobile terminals (e.g., mobile terminals 120); and resource allocation and deconfliction of beamformed spot beams (e.g., beamformed spot beams 150) via an antenna array 810.

Beam manager 805 may be located within a ground network (e.g., ground network 135 of FIG. 1) or a satellite network (e.g., satellite network 101 of FIG. 1) of the satellite communications system. Alternatively, beam manager 805 may be divided between the ground network and the satellite network. In one example (e.g., corresponding to a GBBF configuration), all of the components of beam manager 805 may be located in the ground network. In another example (e.g., corresponding to an OBBF configuration), the beamformer 845 may be located in the satellite network (e.g., in one or more of the satellites) and the rest of the components of beam manager 805 may each be located in either the ground network or the satellite network. In some examples, a distributed implementation may be used. For example, one or more components or portions thereof of beam manager 805 may reside on different servers (e.g., hosted in the cloud). In some examples, beam manager 805 may be located at a single entity (e.g., central server 180).

Antenna array 810 may be an example of the antennas of the satellite network 101 of FIG. 1 and may include antenna elements 815. In some examples, one or more of the antenna elements 815 may be or include an antenna panel. The spacing between antenna elements 815 may be evenly distributed across an aperture of antenna array 810, or the spacing of antenna elements 815 may be different across antenna array 810. In some examples, a first antenna array 810 may be included within the ground segment and a second antenna array 810 (e.g., one or more antenna arrays coupled with each other using transponders) may be included within the space segment.

Bus 825 may represent an interface over which signals may be exchanged between components of beam manager 805 and a location (e.g., a central location) that may be used to distribute the signals to the signal processing components of beam manager 805 (e.g., deconfliction manager 870, beam signal processor 850, beamformer 845). Bus 825 may include one or more wired interfaces. Additionally, or alternatively, bus 825 may be a wireless interface that is used to wirelessly communicate signaling between the signal processing components—e.g., in accordance with a communication protocol. Beamformer 845 may be coupled with antenna elements 815 via one or more wired or wireless interfaces.

The memory 830 may include volatile memory (e.g., random access memory (RAM)) and/or non-volatile memory (e.g., read-only memory (ROM)). Other types of memory may also be possible. The memory 830 may store code 835 that is computer-readable and computer-executable. The code may include instructions that, when executed by processor 840, cause beam manager 805 to perform various functions described herein. The code 835 may be stored in a non-transitory computer-readable medium such as system memory or another type of memory. In some cases, the code 835 may not be directly executable by processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

Processor 840 may include an intelligent hardware device (e.g., a general-purpose processor), a digital signal processor (DSP), a central processing unit (CPU), a microcontroller, an application-specific integrated circuit (ASIC), a field programmable gate array (FPGA), a programmable logic device (PLD), a discrete gate or transistor logic component, a discrete hardware component, or any combination thereof. Processor 840 may be configured to execute computer-readable instructions stored in a memory (e.g., memory 830) to cause beam manager 805 to perform various functions (e.g., functions or tasks supporting mobile satellite beam resource allocation). For example, processor 840 and memory 830 may be configured to perform the various functions described herein.

Beam signal processor 850 may be configured to process (e.g., demodulate, decode) receive beam signals 854 received from beamformer 845. Beam signal processor 850 may decode data symbols included in the receive beam signals 854 to obtain receive beam data signals 864. Information (e.g., packets) in receive beam data signals 864 may be passed (e.g., via network(s) 125) to a destination device. Beam signal processor 850 may also be configured to process (e.g., encode, modulate) transmit beam data signals 862 to obtain transmit beam signals 852 to send to beamformer 845. Transmit beam data signals 862 may include information (e.g., packets) received (e.g., via network(s) 125) for transmission to terminals 120.

Deconfliction manager 870 may be configured to determine resource element changes for each beam and direct the execution of those resource element changes. For example, if a new time slot is to be assigned to a beam, deconfliction manager 870 may compute new beamforming coefficients based on CSI from all the beams active in that time slot and may also determine desired power, modulation and/or coding for that time slot, either by calculation or by requesting signal-to-noise ratio reports from the terminal associated with the beam. In another example, if a beam is to be moved to a new frequency range or channel, then the CSI and beamforming coefficients from the old channel may be inapplicable in the new channel due to variability of RF characteristics from channel to channel. Deconfliction manager 870 may cause channel probing signals to be transmitted in the new frequency channel and instruct the terminal associated with the beam to: switch to the new channel, process the probing signal, switch back to the original channel, and report the CSI information back to beam manager 805. To avoid packet loss during this operation, the scheduling of data packets may be paused during the reception of the channel probe signal in the new channel. Deconfliction manager 870 may include a terminal tracker 820 and an allocation manager 875. In some examples, beam manager 805 may be located at a single entity (e.g., central server 180).

Terminal tracker 820 may be configured to determine information for beamformer 845 to use in forming beamformed spot beams (e.g., beamformed spot beams 150 of FIG. 1) using antenna elements 815. To determine the information for forming the beamformed spot beams, terminal tracker 820 may identify a set of terminals (e.g., mobile terminals 120 of FIG. 1) to be assigned as reference terminals, and may determine spatial information associated with the reference terminals. Terminal tracker 820 may determine a set of beamforming coefficients (e.g., phase shifts, amplitude components) that beamformer 845 may use to generate beamformed spot beams having individual coverage areas directed to the spatial information associated with the reference terminals.

Terminal tracker 820 may determine the beamforming coefficients to isolate signals transmitted over beamformed spot beams from one another—e.g., by, for each beamformed spot beam, emphasizing the signals transmitted within the beamformed spot beam and canceling interference from signals transmitted within other beamformed spot beams. The beamforming coefficients may be included in an M×N matrix, where a value of M may indicate the quantity of antennas and a value of N may indicate the quantity of spatial layers, where the value of N may be less than or equal to the value of M.

In some examples, the beamforming coefficients may be determined at the one or more satellites 105. In some examples, the beamforming coefficients may be received by the one or more satellites from one or more ground stations (e.g., network devices 130 or other stations of ground network 135) after terminal tracker 820 determines the beamforming coefficients

Allocation manager 875 may be configured to perform beam resource allocation and reallocation, including coordinating resource elements used by the beams. For example, allocation manager 875 may determine, for allocation of each beamformed spot beam: one or more frequency ranges or channels (e.g., a frequency channel 210 of FIG. 2B); one or more time periods and/or time slots (e.g., time period 215, time slot t of FIG. 2B); and/or a polarity. To allocate the beams to the determined resource elements, allocation manager 875 may include various components, such as frequency converters, schedulers, and polarization components. Allocation manager 875 may be further configured to keep track of which resource elements each beamformed spot beam is assigned to and to determine when reallocation of a beam may be desired. In some examples, allocation manager 875 may comprise separate subsystems. For example, one subsystem may determine which resources to assign to each beam and another subsystem may orchestrate the process of seamlessly reallocating the resources so that no packets are dropped. In some examples, allocation manager 875 may be divided between multiple devices and/or locations. In some examples, allocation manager 875 may be located at a single entity (e.g., central server 180).

In some examples, for transmission of beamformed spot beams via antenna elements 815, allocation manager 875 may determine frequency ranges or channels and time periods and time slots for applying to a set of transmit beam signals 852 associated with the beamformed spot beams. Beamformer 845 may apply, based on the frequency ranges or channels, the set of transmit beamforming coefficients to the set of transmit beam signals 852 to obtain component signals 856 for transmission via antenna elements 815.

In some examples, for reception of beamformed spot beams via antenna elements 815, terminal tracker 820 may determine a set of receive beamforming coefficients, based on frequency ranges or channels determined by allocation manager 875, to obtain a set of component signals 856. The frequency ranges or channels and time periods and time slots may be applied to the component signals 856 by allocation manager 875 or beamformer 845 to obtain a set of receive beam signals 854 associated with the beamformed spot beams.

In some examples, terminal tracker 820, allocation manager 875, beamformer 845, beam signal processor 850, or various combinations or components thereof, may be implemented in hardware (e.g., in communications management circuitry). The hardware may include a processor, a DSP, an ASIC, an FPGA or other PLD, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, terminal tracker 820, allocation manager 875, beamformer 845, beam signal processor 850, or various combinations or components thereof, may be implemented in code 835 (e.g., as communications management software or firmware), executed by processor 840. If implemented in code 835 executed by processor 840, the functions of terminal tracker 820, allocation manager 875, beamformer 845, beam signal processor 850, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

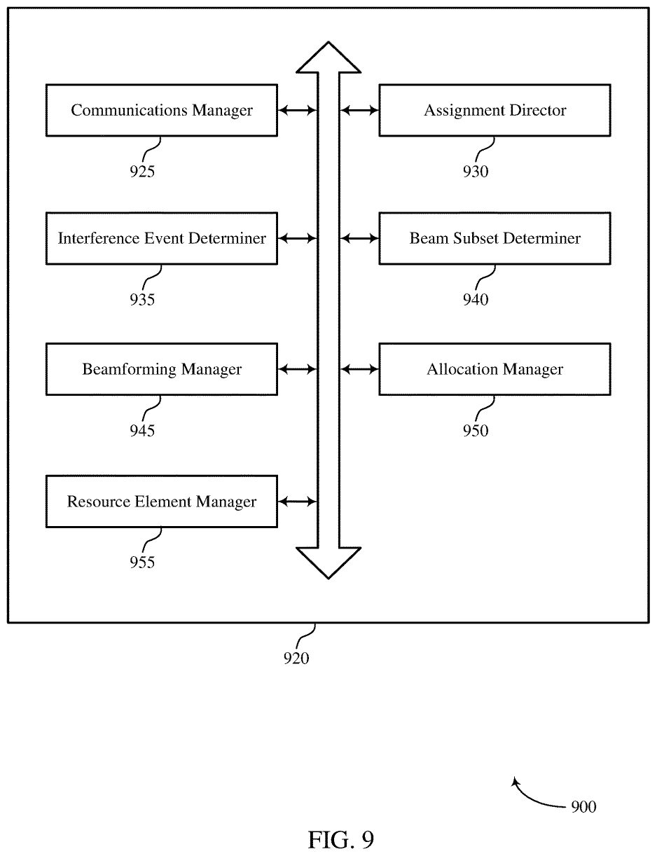

FIG. 9 shows a block diagram 900 of a deconfliction manager 920 that supports mobile satellite beam resource allocation in accordance with examples as disclosed herein. Deconfliction manager 920 may be an example of aspects of deconfliction manager 870 as described with reference to FIG. 8. Deconfliction manager 920, or various components thereof, may be an example of means for performing various aspects of mobile satellite beam resource allocation as described herein. For example, deconfliction manager 920 may include a communications manager 925, an assignment director 930, an interference event determiner 935, a beam subset determiner 940, a beamforming manager 945, an allocation manager 950, a resource element manager 955, or any combination thereof. Each of these components may communicate, directly or indirectly, with one another (e.g., via one or more buses).

The communications manager 925 may be configured as or otherwise support a means for providing a communication service to a plurality of mobile terminals via a set of beamformed spot beams of a satellite communication system, as discussed herein. Each mobile terminal may be assigned to a beamformed spot beam. In some examples, the communications manager 925 may be configured as or otherwise support a means for providing a communication service to first, second, and third mobile terminals via first, second, and third beamformed spot beams, respectively, as discussed herein. In some examples, the communications manager 925 may comprise one or more of the other components of deconfliction manager 920. In some examples, the communications manager 925 may comprise the assignment director 930, the interference event determiner 935, the beam subset determiner 940, the beamforming manager 945, the allocation manager 950, and the resource element manager 955. In some examples, the communications manager 925 may comprise the beamforming manager 945, the interference event determiner 935, and the assignment director 930

The beamforming manager 945 may be configured as or otherwise support a means for adjusting respective coverage areas of the set of beamformed spot beams over a plurality of time periods to track movement of the plurality of mobile terminals within a coverage area of the satellite communication system, as discussed herein. In some examples, the beamforming manager 945 may be configured as or otherwise support a means for adjusting respective coverage areas of the first, second, and third beamformed spot beams over a plurality of time periods to track movement of the first, second, and third mobile terminals within a coverage area of the satellite communication system, as discussed herein.

The allocation manager 950 may be configured as or otherwise support a means for performing resource element allocation and reallocation for the set of beamformed spot beams, as discussed herein. The allocation manager 950 may be an example of aspects of allocation manager 875 as described with reference to FIG. 8. In some examples, the allocation manager 950 may comprise one or more of the other components of deconfliction manager 920. In some examples, the allocation manager 950 may comprise the interference event determiner 935, the beam subset determiner 940, the resource element manager 955, and the assignment director 930. In some examples, the allocation manager 950 may be performed at a single entity (e.g., a central server 180)

The interference event determiner 935 may be configured as or otherwise support a means for determining (e.g., at a central server) one or more interference events associated with the set of beamformed spot beams for a current time period. The determining may be based on interference metrics of beamformed spot beams each satisfying a threshold value. In some examples, the interference event determiner 935 may be configured as or otherwise support a means for determining that an interference metric of the first and second beamformed spot beams each satisfies a threshold value, and an interference metric of the third beamformed spot beam fails to satisfy the threshold value. The determining may be based on adjusting the respective coverage areas of the beamformed spot beams,

The beam subset determiner 940 may be configured as or otherwise support a means for determining (e.g., at a central server) a subset of the set of beamformed spot beams for resource element reassignment associated with a next time period. The determining may be based on determining the one or more interference events for the current time period.

The resource element manager 955 may be configured as or otherwise support a means for determining (e.g., at a central server) respective one or more resource elements to associate with each beamformed spot beam for the next time period. For each beamformed spot beam, the respective one or more resource elements for the next time period may be different than the one or more resource elements to which the beamformed spot beam is assigned for the current time period.

The assignment director 930 may be configured as or otherwise support a means for directing (e.g., at a central server) assignment of each beamformed spot beam to one or more resource elements. The assignment director 930 may also be configured as or otherwise support a means for directing reassignment of each beamformed spot beam to the respective one or more resource elements for the next time period. In some examples, the assignment director 930 may be configured as or otherwise support a means for assigning the first beamformed spot beam to the first resource element, the second beamformed spot beam to the second resource element, and the third beamformed spot beam to the first and second resource elements. The assigning may be based on the determination that the interference metrics of the first and second beamformed spot beams each satisfies the threshold value, and the interference metric of the third beamformed spot beam fails to satisfy the threshold value.

In some examples, aspects of one or more components of deconfliction manager 870 or 920 may be found in other components of the beam/terminal block or even outside of the beam/terminal block. For example, processor 840 and memory 830 may be used in performing one or more functions associated with the components of deconfliction manager 920.

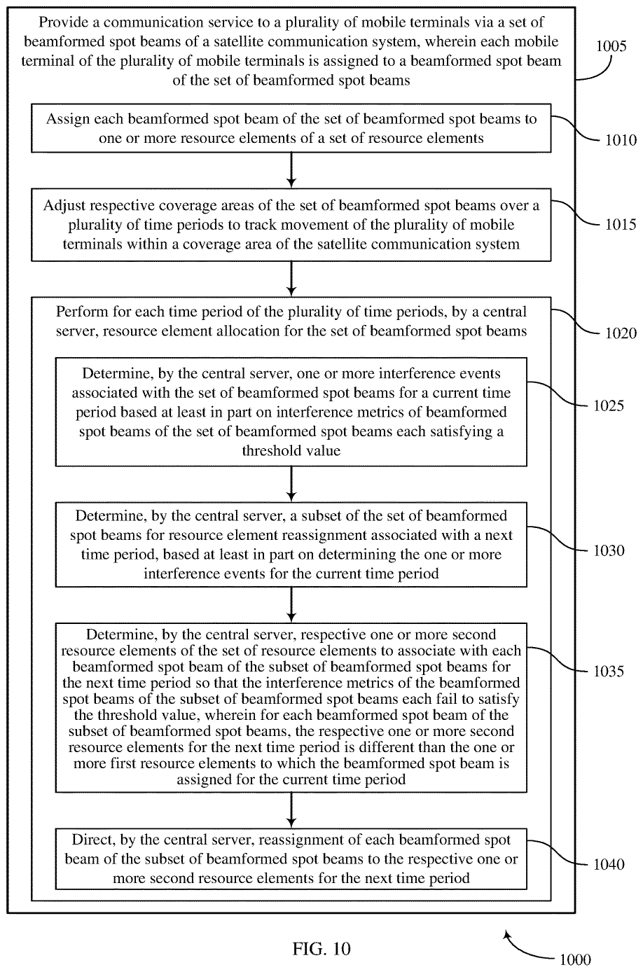

FIG. 10 shows a flowchart illustrating a method 1000 that supports mobile satellite beam resource allocation in accordance with examples as disclosed herein. The operations of method 1000 may be implemented by a satellite communication system or its components as described herein. For example, the operations of method 1000 may be performed by a beam manager as described with reference to FIGS. 1 through 9. In some examples, a processor may execute a set of instructions to control the functional elements of the beam manager to perform the described functions. Additionally, or alternatively, the beam manager may perform aspects of the described functions using special-purpose hardware.

At 1005, the method may include providing a communication service to a plurality of mobile terminals via a set of beamformed spot beams of a satellite communication system, wherein each mobile terminal of the plurality of mobile terminals is assigned to a beamformed spot beam of the set of beamformed spot beams. The operations of 1005 may be performed in accordance with examples as disclosed herein. In some examples, aspects of the operations of 1005 may be performed by a communications manager 925 as described with reference to FIG. 9. In some examples, providing the communication service may include the operations of 1010, 1015, 1020, 1025, 1030, 1035, and 1040.

At 1010, the method may include assigning each beamformed spot beam of the set of beamformed spot beams to one or more first resource elements of a set of resource elements. The operations of 1010 may be performed in accordance with examples as disclosed herein. In some examples, aspects of the operations of 1010 may be performed by an assignment director 930 as described with reference to FIG. 9.

At 1015, the method may include adjusting respective coverage areas of the set of beamformed spot beams over a plurality of time periods to track movement of the plurality of mobile terminals within a coverage area of the satellite communication system. The operations of 1015 may be performed in accordance with examples as disclosed herein. In some examples, aspects of the operations of 1015 may be performed by a beamforming manager 945 as described with reference to FIG. 9.

At 1020, the method may include performing, by a central server, resource element allocation for the set of beamformed spot beams. Performing the resource element allocation may include the operations of 1025, 1030, 1035, and 1040. The operations of 1020 may be performed in accordance with examples as disclosed herein. In some examples, aspects of the operations of 1020 may be performed by an allocation manager 950 as described with reference to FIG. 9.

At 1025, performing the resource element allocation may include, for each time period, determining, by the central server, one or more interference events associated with the set of beamformed spot beams for a current time period based at least in part on interference metrics of beamformed spot beams of the set of beamformed spot beams each satisfying a threshold value. The operations of 1025 may be performed in accordance with examples as disclosed herein. In some examples, aspects of the operations of 1025 may be performed by an interference event determiner 935 as described with reference to FIG. 9.

At 1030, performing the resource element allocation may include, for each time period, determining, by the central server, a subset of the set of beamformed spot beams for resource element reassignment associated with a next time period, based at least in part on determining the one or more interference events for the current time period. The operations of 1030 may be performed in accordance with examples as disclosed herein. In some examples, aspects of the operations of 1030 may be performed by a beam subset determiner 940 as described with reference to FIG. 9.

At 1035, performing the resource element allocation may include, for each time period, determining, by the central server, respective one or more second resource elements of the set of resource elements to associate with each beamformed spot beam of the subset of beamformed spot beams for the next time period so that the interference metrics of the beamformed spot beams of the subset of beamformed spot beams each fail to satisfy the threshold value, wherein for each beamformed spot beam of the subset of beamformed spot beams, the respective one or more second resource elements for the next time period is different than the one or more first resource elements to which the beamformed spot beam is assigned for the current time period. The operations of 1035 may be performed in accordance with examples as disclosed herein. In some examples, aspects of the operations of 1035 may be performed by a resource element manager 955 as described with reference to FIG. 9.

At 1040, performing the resource element allocation may include, for each time period, directing, by the central server, reassignment of each beamformed spot beam of the subset of beamformed spot beams to the respective one or more second resource elements for the next time period. The operations of 1040 may be performed in accordance with examples as disclosed herein. In some examples, aspects of the operations of 1040 may be performed by an assignment director 930 as described with reference to FIG. 9.

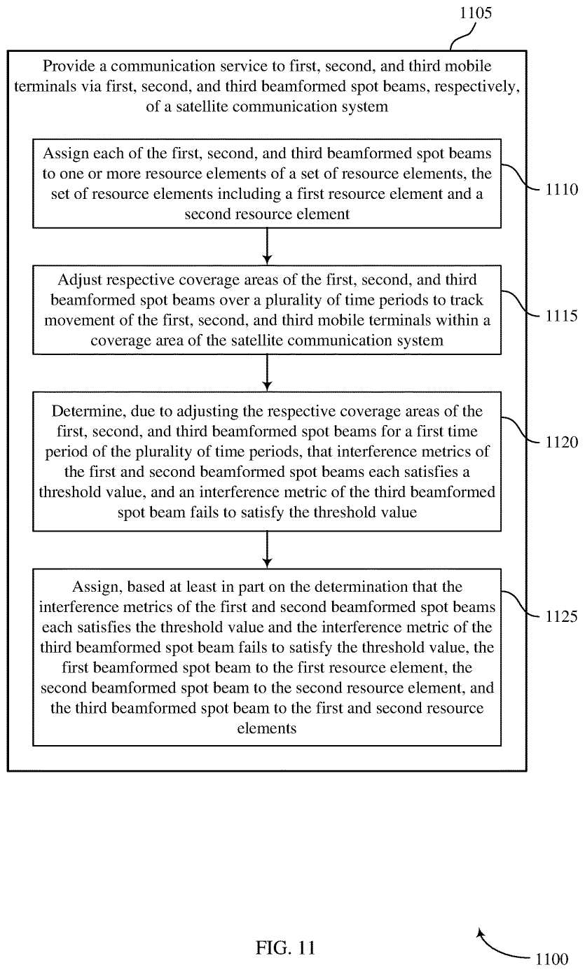

FIG. 11 shows a flowchart illustrating a method 1100 that supports mobile satellite beam resource allocation in accordance with examples as disclosed herein. The operations of method 1100 may be implemented by a beam manager or its components as described herein. For example, the operations of method 1100 may be performed by a beam manager as described with reference to FIGS. 1 through 9. In some examples, a processor may execute a set of instructions to control the functional elements of the beam manager to perform the described functions. Additionally, or alternatively, the beam manager may perform aspects of the described functions using special-purpose hardware.

At 1105, the method may include providing a communication service to first, second, and third mobile terminals via first, second, and third beamformed spot beams, respectively, of a satellite communication system. The operations of 1105 may be performed in accordance with examples as disclosed herein. In some examples, aspects of the operations of 1105 may be performed by a communications manager 925 as described with reference to FIG. 9.

At 1110, the method may include assigning each of the first, second, and third beamformed spot beams to one or more resource elements of a set of resource elements, the set of resource elements including a first resource element and a second resource element. The operations of 1110 may be performed in accordance with examples as disclosed herein. In some examples, aspects of the operations of 1110 may be performed by an assignment director 930 as described with reference to FIG. 9.

At 1115, the method may include adjusting respective coverage areas of the first, second, and third beamformed spot beams over a plurality of time periods to track movement of the first, second, and third mobile terminals within a coverage area of the satellite communication system. The operations of 1115 may be performed in accordance with examples as disclosed herein. In some examples, aspects of the operations of 1115 may be performed by a beamforming manager 945 as described with reference to FIG. 9.

At 1120, the method may include determining, due to adjusting the respective coverage areas of the first, second, and third beamformed spot beams for a first time period of the plurality of time periods, that interference metrics of the first and second beamformed spot beams each satisfies a threshold value, and an interference metric of the third beamformed spot beams fails to satisfy the threshold value. The operations of 1120 may be performed in accordance with examples as disclosed herein. In some examples, aspects of the operations of 1120 may be performed by an interference event determiner 935 as described with reference to FIG. 9.

At 1125, the method may include assigning, based at least in part on the determination that the interference metrics of the first and second beamformed spot beams each satisfies the threshold value and the interference metric of the third beamformed spot beam fails to satisfy the threshold value, the first beamformed spot beam to the first resource element, the second beamformed spot beam to the second resource element, and the third beamformed spot beam to the first and second resource elements. The operations of 1125 may be performed in accordance with examples as disclosed herein. In some examples, aspects of the operations of 1125 may be performed by an assignment director 930 as described with reference to FIG. 9.

In some examples, an apparatus as described herein may perform a method or methods, such as method 1000 and/or method 1100. The apparatus may include features, circuitry, logic, means, or instructions (e.g., a non-transitory computer-readable medium storing instructions executable by a processor), or any combination thereof for performing the method or methods.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer readable media may include RAM, ROM, electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method comprising:
providing a communication service to a plurality of mobile terminals via a set of beamformed spot beams of a satellite communication system, wherein each mobile terminal of the plurality of mobile terminals is assigned to a beamformed spot beam of the set of beamformed spot beams, and wherein providing the communication service comprises:
assigning each beamformed spot beam of the set of beamformed spot beams to one or more first resource elements of a set of resource elements; and
adjusting respective coverage areas of the set of beamformed spot beams over a plurality of time periods such that the respective coverage areas track movement of the plurality of mobile terminals within a coverage area of the satellite communication system; and
performing, by a central server, resource element allocation for the set of beamformed spot beams, wherein performing the resource element allocation comprises, for each time period of the plurality of time periods:
determining, by the central server, one or more interference events due to the adjustment of the coverage areas of the set of beamformed spot beams for a current time period based at least in part on interference metrics of beamformed spot beams of the set of beamformed spot beams each satisfying a threshold value;
determining, by the central server, a subset of the set of beamformed spot beams for resource element reassignment associated with a next time period, based at least in part on determining the one or more interference events for the current time period;
determining, by the central server, respective one or more second resource elements of the set of resource elements to associate with each beamformed spot beam of the subset of beamformed spot beams for the next time period so that the interference metrics of the beamformed spot beams of the subset of beamformed spot beams each fail to satisfy the threshold value, wherein for each beamformed spot beam of the subset of beamformed spot beams, the respective one or more second resource elements for the next time period is different than the one or more first resource elements to which the beamformed spot beam is assigned for the current time period; and
directing, by the central server, reassignment of each beamformed spot beam of the subset of beamformed spot beams to the respective one or more second resource elements for the next time period.

2. The method of claim 1, wherein for each time period, directing the reassignment for the next time period comprises:
directing, by the central server, one or more satellites associated with the subset of beamformed spot beams to implement the reassignment at a specific time.

3. The method of claim 1, wherein for each time period, directing the reassignment for the next time period comprises:
notifying, by the central server, respective mobile terminals associated with the subset of beamformed spot beams of the reassignment.

4. The method of claim 1, wherein for each time period, performing the resource element allocation further comprises:
collecting, by the central server, information associated with the plurality of mobile terminals and the set of beamformed spot beams for the time period, wherein determining the one or more interference events is based at least in part on the collected information.

5. The method of claim 1, wherein for each time period, performing the resource element allocation further comprises:
determining, by the central server, respective locations of the plurality of mobile terminals for the current time period, wherein determining the one or more interference events is based at least in part on determining the respective locations of the plurality of mobile terminals.

6. The method of claim 1, wherein for each time period, determining the subset of beamformed spot beams for resource element reassignment comprises:
determining, by the central server, that an interference metric of a first beamformed spot beam associated with a first mobile terminal satisfies a threshold due to the adjustment of the coverage area of the first beamformed spot beam; and
determining, by the central server, based at least in part on the determining that the interference metric of the first beamformed spot beam satisfies the threshold, that the subset of beamformed spot beams includes the first beamformed spot beam.

7. The method of claim 6, wherein for each time period, directing the reassignment of each beamformed spot beam for the next time period comprises:
sending, by the central server, a control signal to the first mobile terminal.

8. The method of claim 1, wherein for each time period, performing the resource element allocation further comprises:
determining, for the current time period by the central server, respective one or more resource elements for each beamformed spot beam of the subset of beamformed spot beams, wherein determining the one or more interference events is based at least in part on determining the respective one or more resource elements for each beamformed spot beam for the current time period.

9. The method of claim 1, wherein each time period comprises a same duration of time.

10. The method of claim 1, wherein the interference metrics of the beamformed spot beams are based on one or more of:
a measured interference between beamformed spot beams of the set of beamformed spot beams,
an estimated interference between beamformed spot beams of the set of beamformed spot beams,
a correlation between channels of the plurality of mobile terminals, or a distance between mobile terminals of the plurality of mobile terminals.

11-22. (canceled)

23. A system for satellite communications, comprising:
one or more satellites;
a beam manager configured to provide a communication service to a plurality of mobile terminals via a set of beamformed spot beams, wherein each mobile terminal of the plurality of mobile terminals is assigned to a beamformed spot beam of the set of beamformed spot beams, and wherein to provide the communication service, the beam manager is configured to:
assign each beamformed spot beam of the set of beamformed spot beams to one or more first resource elements of a set of resource elements; and
adjust respective coverage areas of the set of beamformed spot beams over a plurality of time periods such that the respective coverage areas track movement of the plurality of mobile terminals within a coverage area of the system for satellite communications; and
a central server configured to perform resource element allocation for the set of beamformed spot beams, wherein to perform the resource element allocation, the central server is configured, for each time period of the plurality of time periods, to:
determine, by the central server, one or more interference events due to the adjustment of the coverage areas of the set of beamformed spot beams for a current time period based at least in part on interference metrics of beamformed spot beams of the set of beamformed spot beams each satisfying a threshold value;
determine, by the central server, a subset of the set of beamformed spot beams for resource element reassignment associated with a next time period, based at least in part on determining the one or more interference events for the current time period;
determine, by the central server, respective one or more second resource elements of the set of resource elements to associate with each beamformed spot beam of the subset of beamformed spot beams for the next time period so that the interference metrics of the beamformed spot beams of the subset of beamformed spot beams each fail to satisfy the threshold value, wherein for each beamformed spot beam of the subset of beamformed spot beams, the respective one or more second resource elements for the next time period is different than the one or more first resource elements to which the beamformed spot beam is assigned for the current time period; and
direct, by the central server, reassignment of each beamformed spot beam of the subset of beamformed spot beams to the respective one or more second resource elements for the next time period.

24. The system of claim 23, wherein for each time period, to direct the reassignment for the next time period, the central server is further configured to:
direct, by the central server, one or more satellites associated with the subset of beamformed spot beams to implement the reassignment at a specific time.

25. The system of claim 23, wherein for each time period, to direct the reassignment for the next time period, the central server is further configured to:
notify, by the central server, respective mobile terminals associated with the subset of beamformed spot beams of the reassignment.

26. The system of claim 23, wherein for each time period, to perform the resource element allocation, the central server is further configured to:
collect, by the central server, information associated with the plurality of mobile terminals and the set of beamformed spot beams for the time period, wherein determining the one or more interference events is based at least in part on the collected information.

27. The system of claim 23, wherein for each time period, to perform the resource element allocation, the central server is further configured to:
determine, by the central server, respective locations of the plurality of mobile terminals for the current time period, wherein determining the one or more interference events is based at least in part on determining the respective locations of the plurality of mobile terminals.

28. The system of claim 23, wherein for each time period, to determine the subset of beamformed spot beams for resource element reassignment, the central server is further configured to:
determine, by the central server, that an interference metric of a first beamformed spot beam associated with a first mobile terminal satisfies a threshold due to the adjustment of the coverage area of the first beamformed spot beam; and
determine, by the central server, based at least in part on the determining that the interference metric of the first beamformed spot beam satisfies the threshold, that the subset of beamformed spot beams includes the first beamformed spot beam.

29. The system of claim 28, wherein for each time period, to direct the reassignment of each beamformed spot beam for the next time period, the central server is further configured to:
send, by the central server, a control signal to the first mobile terminal.

30. The system of claim 23, wherein for each time period, to perform the resource element allocation, the central server is further configured to:
determine, for the current time period by the central server, respective one or more resource elements for each beamformed spot beam of the subset of beamformed spot beams, wherein determining the one or more interference events is based at least in part on determining the respective one or more resource elements for each beamformed spot beam for the current time period.

31. The system of claim 23, wherein each time period comprises a same duration of time.

32. The system of claim 23, wherein the interference metrics of the beamformed spot beams are based on one or more of:
a measured interference between beamformed spot beams of the set of beamformed spot beams,
an estimated interference between beamformed spot beams of the set of beamformed spot beams,
a correlation between channels of the plurality of mobile terminals, or
a distance between mobile terminals of the plurality of mobile terminals.

33. (canceled)
